(19) United States
(12) Patent Application Publication
(10) Pub. No.: US 2006/0023151 A1
(43) Pub. Date: Feb. 2, 2006

(54) Liquid crystal display and panel therefor

(75) Inventors: Hi-Kuk Lee, Yongin-si (KR); Dong-Ki Lee, Seoul (KR); Jae-Jin Lyu, Gwangju-gun (KR); Nak-Cho Choi, Seoul (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/195,540

(22) Filed: Aug. 1, 2005

(30) Foreign Application Priority Data
Aug. 2, 2004 (KR) 10-2004-0060966
Jan. 13, 2005 (KR) 10-2005-0003223

(51) Int. Cl. G02F 1/1343

(52) U.S. Cl. 349/141

(57) ABSTRACT

A liquid crystal display panel includes a first substrate, a field-generating electrode formed on the substrate, a slope member formed on the substrate and having an inclination angle smaller than about 45 degrees. A portion of the slope member provides a spacer to support another substrate with respect to the first substrate.

### BACKGROUND OF THE INVENTION

1(a) Field of the Invention

The present invention relates to a liquid crystal display and a panel therefor.

2. (b) Description of the Related Art

A liquid crystal display (LCD) is one of the most widely used flat panel displays. An LCD includes two panels provided with field-generating electrodes such as pixel electrodes and a common electrode and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

Among the LCDs, a vertical alignment (VA) mode LCD, which aligns LC molecules such that the long axes of the LC molecules are perpendicular to the panels in absence of electric field, is highly desirable because of its high contrast ratio and wide reference viewing angle that is defined as a viewing angle making the contrast ratio equal to 1:10 or as a limit angle for the inversion in luminance between the grays.

The wide viewing angle of the VA mode LCD can be realized by cutouts in the field-generating electrodes and protrusions on the field-generating electrodes. Since the cutouts and the protrusions can determine the tilt directions of the LC molecules, the tilt directions can be distributed into several directions by using the cutouts and the protrusions such that the reference viewing angle is widened.

However, the LCDs having the cutouts or the protrusions may have large response time. This is because the tilt directions of the liquid crystal molecules far from the cutouts and the protrusions are determined by a pressure of the liquid crystal molecules on the field-generating electrodes or by collision with them and thus the alignment of the liquid crystal molecules is unstable and irregular. Although the response time may be improved by closely spacing the cutouts, this may cause a decrease of the aperture ratio.

In the meantime, a cell gap, which is a distance between two panels of an LCD, is maintained by spherical spacers or columnar spacers. The spherical spacers are spread before the two panels are assembled and thus it is hard to control the positions of the spacers. The columnar spacers are made of thin films using lithography and thus their positions are easily controlled. However, the lithography increases the manufacturing cost.

### SUMMARY OF THE INVENTION

The present invention solves the problems of the conventional art.

A liquid crystal display panel according to an embodiment of the present invention includes: a substrate; a field-generating electrode formed on the substrate; a slope member formed on the substrate and having an inclination angle smaller than about 45 degrees; and a spacer formed of the same layer as the slope member and higher than the slope member.

The liquid crystal display panel may further include a ground member formed of the same layer as the slope member and the spacer and the ground member may be connected to at least one of the slope member and the spacer.

The slope member and the spacer may include a photosensitive organic material.

The inclination angle of the slope member may be in a range of about 1-10 degrees, and the slope member has a gradually decreasing height.

The slope member may have a curved surface and may include a ridge protruding upward.

The field generating electrode may have a cutout that may substantially coincide with a ridge of the slope member.

The slope member may have a ridge substantially coinciding with an edge of the field generating electrode and the slope member may be disposed on the field generating electrode.

A liquid crystal display according to an embodiment of the present invention includes: first and second substrates facing each other; first and second field generating electrodes formed on at least one of the first and the second substrates and facing each other; a liquid crystal layer disposed between the first substrate and the second substrate; a slope member formed on the first substrate and having an inclined surface that reduces response time of the liquid crystal layer; and a spacer formed of the same layer as the slope member and propping the first and the second substrates.

The liquid crystal display may further include a ground member incorporated with the slope member and the spacer.

The inclination angle of the slope member may be in a range of about 1-10 degrees and the slope member may have a gradually decreasing height.

The liquid crystal display may further include a tilt direction determining member that determines tilt directions of liquid crystal molecules in the liquid crystal layer under an application of an electric field.

The tilt direction determining member may be disposed on or opposite the slope member.

The slope member may have a ridge arranged alternate to the tilt direction determining member or an edge of the first field generating electrode.

The tilt direction determining member may include a cutout at the first or the second field generating electrode. The tilt direction determining member may be disposed on a ridge of the slope member.

The liquid crystal display may further include: a gate line disposed on the second substrate; a data line intersecting the gate line; and a thin film transistor connected to the gate line, the data line, and one of the first and the second field generating electrodes.

A method of manufacturing a liquid crystal display panel according to an embodiment of the present invention includes: forming a field generating electrode occupying a first area on a substrate; depositing an insulating layer; and patterning the insulating layer to form a plurality of slope members and a plurality of spacers higher than the slope members. The slope members satisfy at least one of: (a) each of the slope members has an inclination angle of about 1-10 degrees; (b) the slope members occupy a second area larger than half of the first area; and (c) each of the slope members has a gradually decreasing height from a ridge.

The patterning of the insulating layer may further form ground portions connected to the slope members and the spacers and thinner than the slope members.

The insulating layer may have photosensitivity.

A liquid crystal display panel according to another embodiment of the present invention includes: a substrate; a field-generating electrode formed on the substrate and occupying a first area; and at least one slope member formed on the field generating electrode and occupying a second area larger smaller than the first area; and the at least one slope member satisfies at least one of: (a) the least one slope member has an inclination angle smaller than about 45 degrees; and (b) each of the slope members has a gradually decreasing height from a ridge.

The least one slope member may have an inclination angle of about 1-10 degrees.

The second area may be equal to or smaller than about a half of the first area and preferably equal to about 25-47.5% of the first area.

The height of the at least one slope member may be in a range of about 0.8-1.2 microns.

The liquid crystal display panel may further include a spacer formed of the same layer as the at least one slope member and higher than the slope member.

The field generating electrode may have a cutout, and the slope member may have a ridge substantially coinciding with the cutout.

### BRIEF DESCRIPTION OF THE DRAWINGS

The present invention will become more apparent by describing embodiments thereof in detail with reference to the accompanying drawings in which:

FIG. 1 is a layout view of a TFT array panel of an LCD according to an embodiment of the present invention;

FIG. 2 is a layout view of a common electrode panel of an LCD according to an embodiment of the present invention;

FIG. 3 is a layout view of an LCD including the TFT array panel shown in FIG. 1 and the common electrode panel shown in FIG. 2;

FIG. 4 is a sectional view of the LCD shown in FIG. 3 taken along line IV-IV′;

FIG. 5 is a table illustrating measured response time of liquid crystal for slope members having various inclination angles;

FIG. 6 is a layout view of an LCD according to another embodiment of the present invention;

FIG. 7 is a sectional view of the LCD shown in FIG. 6 taken along line VII-VII′;

FIG. 8 is a layout view of a common electrode panel for an LCD according to another embodiment of the present invention;

FIG. 9 is a layout view of an LCD including the TFT array panel shown in FIG. 1 and the common electrode panel shown in FIG. 8;

FIG. 10 is a sectional view of the LCD shown in FIG. 9 taken along line X-X′;

FIG. 11 is a layout view of an LCD according to another embodiment of the present invention;

FIG. 12 is a sectional view of the LCD shown in FIG. 11 taken along line XII-XII′;

FIG. 13 is a sectional view of a common electrode panel and a mask for forming slope members in an intermediate step of a manufacturing method thereof according to an embodiment of the present invention;

FIG. 14 illustrates slits of the mask aligned with a slope member;

FIG. 15A is a sectional view of a common electrode panel according to another embodiment of the present invention;

FIG. 15B illustrates a slope member according to another embodiment of the present invention;

FIG. 16 is a layout view of a TFT array panel for an LCD according to an embodiment of the present invention;

FIG. 17 is a layout view of a common electrode panel for an LCD according to an embodiment of the present invention;

FIG. 18 is a layout view of an LCD including the TFT array panel shown in FIG. 16 and the common electrode panel shown in FIG. 17;

FIG. 19 is a sectional view of the LCD shown in FIG. 18 taken along line XIX-XIX′;

FIG. 20 is a sectional view of the LCD shown in FIG. 18 taken along lines XX-XX′ and XX′-XX″;

FIG. 21 is a layout view of an LCD according to another embodiment of the present invention;

FIGS. 22 and 23 are sectional views of the LCD shown in FIG. 21 taken along lines XXII-XXII′ and XXIII-XXIII′, respectively;

FIG. 24 is a layout view of a common electrode panel for an LCD according to another embodiment of the present invention;

FIG. 25 is a layout view of an LCD including the TFT array panel shown in FIG. 16 and the common electrode panel shown in FIG. 24;

FIGS. 26 and 27 are sectional views of the LCD shown in FIG. 25 taken along lines XXVI-XXVI′ and XXVII-XXVII′, respectively;

FIG. 28 is a sectional view of a common electrode panel shown in FIGS. 23-26 and a mask for forming slope members in an intermediate step of a manufacturing method thereof according to an embodiment of the present invention;

FIG. 29 is a layout view of a TFT array panel of an LCD according to another embodiment of the present invention;

FIG. 30 is a layout view of a common electrode panel of an LCD according to another embodiment of the present invention;

FIG. 31 is a layout view of an LCD including the TFT array panel shown in FIG. 29 and the common electrode panel shown in FIG. 30;

FIG. 32 is a sectional view of the LCD shown in FIG. 31 taken along line XXXII-XXXII′;

FIG. 33 is a layout view of a TFT array panel for an LCD according to another embodiment of the present invention;

FIG. 34 is a layout view of a common electrode panel for an LCD according to another embodiment of the present invention;

FIG. 35 is a layout view of an LCD including the TFT array panel shown in FIG. 33 and the common electrode panel shown in FIG. 34;

FIG. 36 is a sectional view of the LCD shown in FIG. 35 taken along line XXXVI-XXXVI′;

FIG. 37 is a layout view of an LCD according to another embodiment of the present invention; and

FIG. 38 is a sectional view of the LCD shown in FIG. 37 taken along line XXXII-XXXII′.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

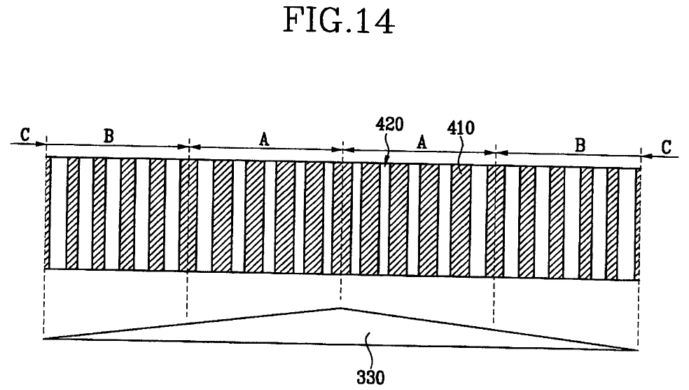

An LCD according to an embodiment of the present invention is described below with reference to FIGS. 14.

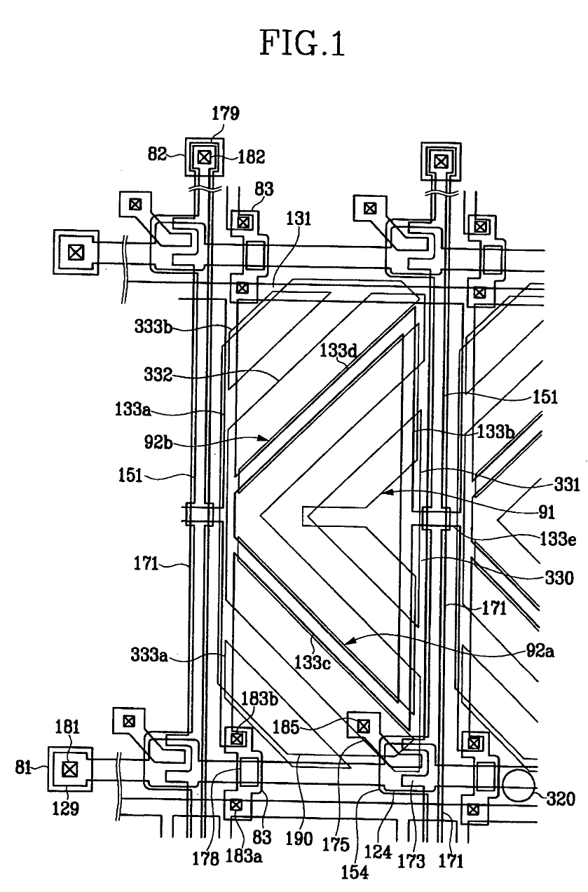

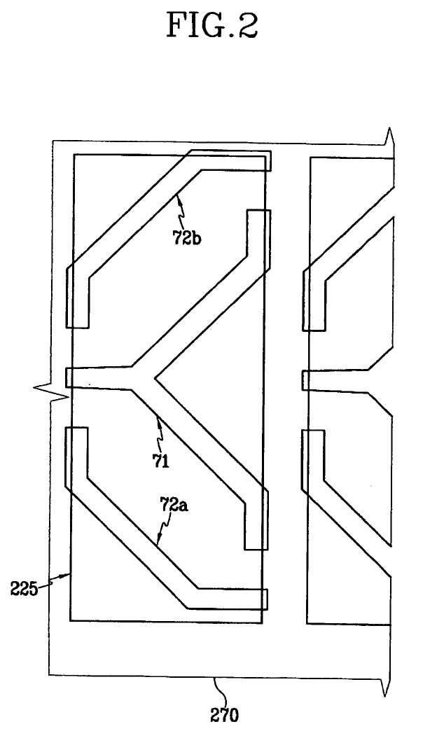

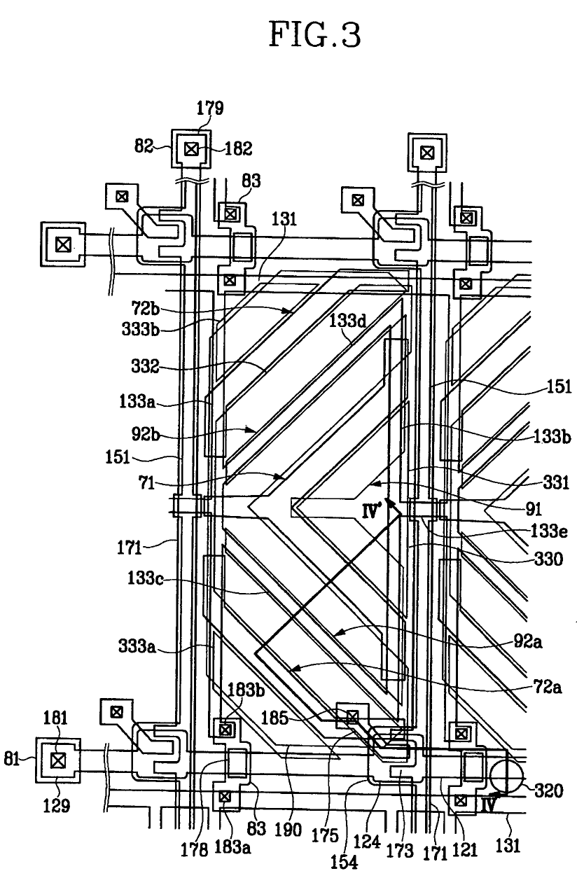

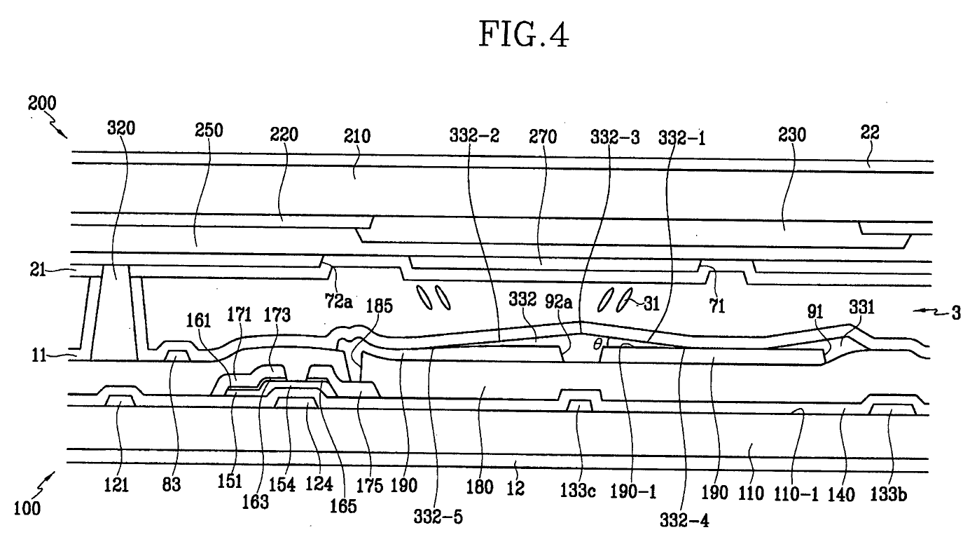

FIG. 1 is a layout view of a TFT array panel of an LCD according to an embodiment of the present invention, FIG. 2 is a layout view of a common electrode panel of an LCD according to an embodiment of the present invention, FIG. 3 is a layout view of an LCD including the TFT array panel shown in FIG. 1 and the common electrode panel shown in FIG. 2, and FIG. 4 is a sectional view of the LCD shown in FIG. 3 taken along line IV-IV′.

An LCD according to an embodiment of the present invention includes a TFT array panel 100, a common electrode panel 200, and a LC layer 3 interposed between the panels 100 and 200.

The TFT array panel 100 is now described in detail with reference FIGS. 1, 3 and 4.

A plurality of gate lines 121 and a plurality of storage electrode lines 131 are formed on an insulating substrate 110 such as transparent glass or plastic.

The gate lines 121 transmit gate signals and extend substantially in a transverse direction. Each gate line 121 includes a plurality of gate electrodes 124 protruding upward and downward and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the TFT array panel 100.

The storage electrodes 131 are supplied with a predetermined voltage and each storage electrode line 131 includes a stem extending substantially parallel to the gate lines 121, a plurality of sets of branches 133a-133d, and a plurality of connections 133e connecting the branches 133a-133d. Each storage electrode line 131 is disposed between two adjacent gate lines 121 and the stem is close to upper one of the two adjacent gate lines 121.

A set of branches 133a-133d includes two longitudinal branches forming first and second storage electrodes 133a and 133b and spaced apart from each other and two oblique branches forming third and fourth storage electrodes 133c and 133d and connected between the first and the second storage electrodes 133a and 133b. In detail, the first storage electrode 133a has a free end portion and a fixed end portion that is connected to the storage electrode line 131 and has a projection. The third and the fourth storage electrodes 133c and 133d extend approximately from a center of the first storage 133a and lower and upper ends of the second storage electrode 133b, respectively.

Each of the connections 133e is connected between a first storage electrode 133a of a set of storage electrodes 133a-133d and a second storage electrode 133b of another set of storage electrodes 133a-133d adjacent thereto.

However, the storage electrode lines 131 may have various shapes and arrangements.

The gate lines 121 and the storage electrode lines 131 are preferably made of Al containing metal such as Al and Al alloy, Ag containing metal such as Ag and Ag alloy, Cu containing metal such as Cu and Cu alloy, Mo containing metal such as Mo and Mo alloy, Cr, Ta, or Ti. However, they may have a multi-layered structure including two conductive films (not shown) having different physical characteristics. One of the two films is preferably made of low resistivity metal including Al containing metal, Ag containing metal, and Cu containing metal for reducing signal delay or voltage drop. The other film is preferably made of material such as Mo containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate lines 121 and the storage electrode lines 131 may be made of various metals or conductors.

The lateral sides of the gate lines 121 and the storage electrode lines 131 are inclined relative to a surface of the substrate, and the inclination angle thereof ranges about 20-80 degrees.

A gate insulating layer 140 preferably made of silicon nitride (SiNx) or silicon oxide (SiOx) is formed on the gate lines 121 and the storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and become wide near the gate lines 121 and the storage electrode lines 131 such that the semiconductor stripes 151 cover large areas of the gate lines 121 and the storage electrode lines 131. Each semiconductor stripe 151 has a plurality of projections 154 branched out toward the gate electrodes 124.

A plurality of ohmic contact stripes and islands 161 and 165 are formed on the semiconductor stripes 151. The ohmic contact stripes and islands 161 and 165 are preferably made of n+ hydrogenated a-Si heavily doped with n type impurity such as phosphorous or they may be made of silicide. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are inclined relative to the surface of the substrate 110, and the inclination angles thereof are preferably in a range between about 30-80 degrees.

A plurality of data lines 171, a plurality of drain electrodes 175, and a plurality of isolated metal pieces 178 are formed on the ohmic contacts 161 and 165 and the gate insulating layer 140.

The data lines 171 transmit data signals and extend substantially in the longitudinal direction to intersect the gate lines 121 and the stems and the connections 133e of the storage electrode lines 131. Each data line 171 includes a plurality of source electrodes 173 projecting toward the gate electrodes 124 and an end portion 179 having a large area for contact with another layer or an external driving circuit. A data driving circuit (not shown) for generating the data signals may be mounted on a FPC film (not shown), which may be attached to the substrate 110, directly mounted on the substrate 110, or integrated onto the substrate 110. The data lines 171 may extend to be connected to a driving circuit that may be integrated on the TFT array panel 100.

Each drain electrode 175 includes a wide end portion and a narrow end portion. The narrow end portion is partly enclosed by a source electrode 173 that is curved.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The metal pieces 178 are disposed on the gate lines 121 near the end portions of the first storage electrodes 133a.

The data lines 171, the drain electrodes 175, and the metal pieces 178 are preferably made of refractory metal such as Cr, Mo, Ta, Ti, or alloys thereof. However, they may have a multilayered structure including a refractory metal film (not shown) and a low resistivity film (not shown). Good examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data lines 171, the drain electrodes 175, and the metal pieces 178 may be made of various metals or conductors.

The data lines 171, the drain electrodes 175, and the metal pieces 178 have inclined edge profiles, and the inclination angles thereof range about 30-80 degrees.

The ohmic contacts 161 and 165 are interposed only between the underlying semiconductor stripes 151 and the overlying conductors 171 and 175 thereon and reduce the contact resistance therebetween. Although the semiconductor stripes 151 are narrower than the data lines 171 at most places, the width of the semiconductor stripes 151 becomes large near the gate lines 121 as described above, to smooth the profile of the surface, thereby preventing the disconnection of the data lines 171. The projections 154 of the semiconductor stripes 151 include some exposed portions, which are not covered with the data lines 171, the drain electrodes 175, and the metal pieces 178, such as portions located between the source electrodes 173 and the drain electrodes 175.

A passivation layer 180 is formed on the data lines 171, the drain electrodes 175, the metal pieces 178, and the exposed portions of the semiconductor stripes 151. The passivation layer 180 is preferably made of inorganic or organic insulator and it may have a flat top surface. Examples of inorganic insulator include silicon nitride and silicon oxide. The organic insulator may have photosensitivity and dielectric constant less than about 4.0. The passivation layer 180 may include a lower film of inorganic insulator and an upper film of organic insulator such that it takes the excellent insulating characteristics of the organic insulator while preventing the exposed portions of the semiconductor stripes 151 from being damaged by the organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the first storage electrodes 133a and a plurality of contact holes 183b exposing the projections of the free end portions of the first storage electrodes 133a.

A plurality of pixel electrodes 190, a plurality of overpasses 83, and a plurality of contact assistants 81 and 82, are formed on the passivation layer 180. They are preferably made of transparent conductor such as ITO or IZO or reflective conductor such as Ag, Al, Cr, or alloys thereof.

The pixel electrodes 190 are physically and electrically connected to the drain electrodes 175 through the contact holes 185 such that the pixel electrodes 190 receive the data voltages from the drain electrodes 175. The pixel electrodes 190 are supplied with the data voltages and generate electric fields in cooperation with the common electrode 270 of the common electrode panel 200, which determine the orientations of liquid crystal molecules 31 in the liquid crystal layer 3. A pixel electrode 190 and the common electrode 270 form a capacitor referred to as a “liquid crystal capacitor,” which stores applied voltages after the TFT turns off.

A pixel electrode 190 overlaps a storage electrode line 131 including storage electrodes 133a-133d. The pixel electrode 190 and a drain electrode 175 connected thereto and the storage electrode line 131 form an additional capacitor referred to as a “storage capacitor,” which enhances the voltage storing capacity of the liquid crystal capacitor.

Each pixel electrode 190 is approximately a rectangle having chamfered left corners and the chamfered edges of the pixel electrode 190 make an angle of about 45 degrees with the gate lines 121.

Each pixel electrode 190 has a center cutout 91, a lower cutout 92a, and an upper cutout 92b, which partition the pixel electrode 190 into a plurality of partitions. The cutouts 91-92b substantially have an inversion symmetry with respect to an imaginary transverse line bisecting the pixel electrode 190.

The lower and the upper cutouts 92a and 92b obliquely extend from a right edge of the pixel electrode 190 near right corners approximately to a center of a left edge of the pixel electrode 190 and overlap the third and the fourth storage electrodes 133c and 133d, respectively. The lower and the upper cutouts 92a and 92b are disposed at lower and upper halves of the pixel electrode 190, respectively, which can be divided by the imaginary transverse line. The lower and the upper cutouts 92a and 92b make an angle of about 45 degrees to the gate lines 121, and they extend substantially perpendicular to each other.

The center cutout 91 extends along the imaginary transverse line and has an inlet from the right edge of the pixel electrode 190, which has a pair of inclined edges substantially parallel to the lower cutout 92a and the upper cutout 92b, respectively.

Accordingly, the lower half of the pixel electrode 190 is partitioned into two lower partitions by the lower cutout 92a and the upper half of the pixel electrode 190 is also partitioned into two upper partitions by the upper cutout 92b. The number of partitions or the number of the cutouts is varied depending on the design factors such as the size of pixels, the ratio of the transverse edges and the longitudinal edges of the pixel electrode 190, the type and characteristics of the liquid crystal layer 3, and so on.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

The overpasses 83 cross over the gate lines 121 and they are connected to the exposed portions of the storage electrode lines 131 and the exposed projection of the free end portions of the first storage electrodes 133a through the contact holes 183a and 183b , respectively, which are disposed opposite each other with respect to the gate lines 121. The overpasses 83 overlaps the metal pieces 178 and they may be electrically connected to the metal pieces 178. The storage electrode lines 131 including the storage electrodes 133a-133d and the connections 133e along with the overpasses 83 and the metal pieces 178 are used for repairing defects in the gate lines 121, the data lines 171, or the TFTs. The electrical connection between the gate lines 121 and the storage electrode lines 131 for repairing the gate lines 121 is obtained by illuminating the cross points of the gate lines 121 and the overpasses 83 by a laser beam to electrically connect the gate lines 121 to the overpasses 83. In this case, the metal pieces 178 enhance the electrical connection between the gate lines 121 and the overpasses 83.

A plurality of sets of slope members 331-333b and a plurality of columnar spacers 320 are formed on the pixel electrodes 190 and the passivation layer 180. The slope members 331-333b and the spacers 320 are preferably made from a single insulating film that has a dielectric constant preferably equal to or lower than the LC layer 3.

Each set of the slope members 331-333b includes four slope members 331-333b disposed on a pixel electrode 190. Each of the slope members 331-333b has a planar shape of trapezoid, triangle, or chevron having two primary edges and two secondary edges. The primary edges of the slope members 331-333b are parallel to edges of the cutouts 91-92b and the chamfered left edges of the pixel electrode 190 and they are disposed between the cutouts 91-92b or between the cutouts 92a and 92b and the chamfered left edges of the pixel electrode 190. The secondary edges of the slope members 335-336b are parallel to the gate lines 121 or the data lines 171.

Each of the slope members 331-333b has a ridge and inclined surfaces. The ridge is disposed approximately on and extends along center lines of the cutouts 92a and 92b, on the edges of the cutout 91, or on the chamfered edges of the pixel electrode 190. Referring to FIG. 4 and looking at slope member 332, inclined surfaces 332-1 and 332-2 have heights decreasing from the ridge 332-3 to the primary edges 332-4 and 332-5. The height of ridge 332-3 is preferably in a range of about 0.5-2.0 microns, and the inclination angle θ of the inclined surfaces 332-1 and 332-2 relative to the surface 110-1 of the substrate 110 is preferably smaller than about 45 degrees and more preferably in a range of about 1-10 degrees. In FIG. 4, inclination angle θ is shown extending with respect to inclined surface 332-1 relative to surface 190-1 of pixel electrode which is parallel to surface 110-1. The inclined surfaces may be straight or curved, and the inclination angle of the curved surface can be defined as the average inclination angle or the gradient of a right triangle that is perpendicular to the ridge and has a lateral edge connecting a top and a lateral edge point of a slope member 331-333b.

It is preferable that a set of the slope members 331-333b occupy an area equal to or larger than half of a pixel electrode 190. The slope members 331-333b for adjacent pixel electrodes 190 may be connected to each other.

The columnar spacers 320 prop the TFT array panel 100 and the common electrode panel 200 such that they make a gap between the panels 100 and 200. The spacers 320 are disposed on the gate lines 121, but they may be disposed anywhere.

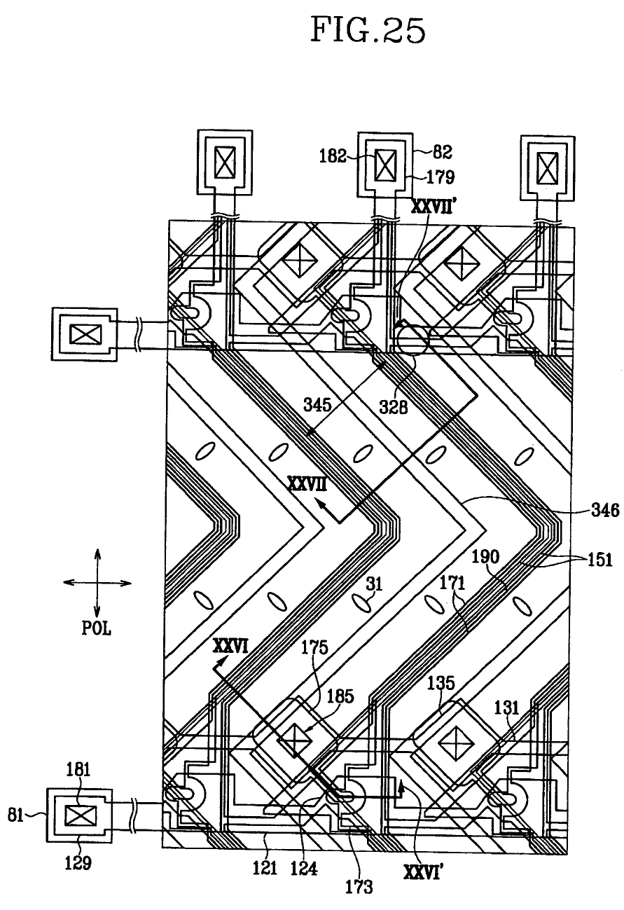

The description of the common electrode panel 200 follows with reference to FIGS. 24.

A light blocking member 220 referred to as a black matrix for preventing light leakage is formed on an insulating substrate 210 such as transparent glass or plastic. The light blocking member 220 may include a plurality of openings 225 that face the pixel electrodes 190 and may have substantially the same planar shape as the pixel electrodes 190. Otherwise, the light blocking member 220 may include linear portions corresponding to the data lines 171 and other portions corresponding to the TFTs.

A plurality of color filters 230 are formed on the substrate 210 and they are disposed substantially in the openings 225 defined by the light blocking member 220. The color filters 230 may extend substantially along the longitudinal direction along the pixel electrodes 190. The color filters 230 may represent one of the primary colors such as red, green and blue.

An overcoat 250 is formed on the color filters 230 and the light blocking member 220. The overcoat 250 prevents the color filters 230 from being exposed and provides a flat surface and it may be omitted.

A common electrode 270 is formed on the overcoat 250. The common electrode 270 is preferably made of transparent conductive material such as ITO and IZO and has a plurality of sets of cutouts 71, 72a and 72b.

A set of cutouts 71-72b face a pixel electrode 190 and include a center cutout 71, a lower cutout 72a, and an upper cutout 72b. Each of the cutouts 71-72b is disposed between adjacent cutouts 91-92b of the pixel electrode 190 or between a cutout 92a or 92b and a chamfered edge of the pixel electrode 190. In addition, each of the cutouts 71-72b has at least an oblique portion extending parallel to the lower cutout 92a or the upper cutout 92b of the pixel electrode 190. The cutouts 71-72b have substantially an inversion symmetry with respect to the above-described transverse line bisecting the pixel electrode 190.

Each of the lower and upper cutouts 72a and 72b includes an oblique portion extending approximately from a left edge of the pixel electrode 190 approximately to lower or upper edge of the pixel electrode 190, and transverse and longitudinal portions extending from respective ends of the oblique portion along edges of the pixel electrode 190, overlapping the edges of the pixel electrode 190, and making obtuse angles with the oblique portion.

The center cutout 71 includes a central transverse portion extending approximately from the left edge of the pixel electrode 190 along the above-described transverse line, a pair of oblique portions extending from an end of the central transverse portion approximately to a right edge of the pixel electrode and making oblique angles with the central transverse portion, and a pair of terminal longitudinal portions extending from the ends of the respective oblique portions along the right edge of the pixel electrode 190, overlapping the right edge of the pixel electrode 190, and making obtuse angles with the respective oblique portions.

The number of the cutouts 71-72b may be varied depending on the design factors, and the light blocking member 220 may also overlap the cutouts 71-72b to block the light leakage through the cutouts 71-72b.

Alignment layers 11 and 21 that may be homeotropic are coated on inner surfaces of the panels 100 and 200, and polarizers 12 and 22 are provided on outer surfaces of the panels 100 and 200 so that their polarization axes may be crossed and one of the transmissive axes may be parallel to the gate lines 121. One of the polarizers may be omitted when the LCD is a reflective LCD.

The LCD may further include at least one retardation film (not shown) for compensating the retardation of the LC layer 3. The retardation film has birefringence and gives a retardation opposite to that given by the LC layer 3. The retardation film may include uniaxial or biaxial optical compensation film, in particular, negative uniaxial compensation film.

The LCD may further include a backlight unit (not shown) supplying light to the LC layer 3 through the polarizers 12 and 22, the retardation film, and the panels 100 and 200.

It is preferable that the LC layer 3 has negative dielectric anisotropy and it is subjected to a vertical alignment that the LC molecules 31 in the LC layer 3 are aligned such that their long axes are substantially vertical to the surfaces of the panels 100 and 200 in absence of electric field.

Upon application of the common voltage to the common electrode 270 and a data voltage to the pixel electrodes 190, an electric field substantially perpendicular to the surfaces of the panels 100 and 200 is generated and both the pixel electrodes 190 and the common electrode 190 are referred to as field generating electrodes. The LC molecules 31 tend to change their orientations in response to the electric field such that their long axes are perpendicular to the field direction. The cutouts 91-92b and 71-72b, the edges of the pixel electrodes 190, and the slope members 331-333b control the tilt directions of the LC molecules 31 in the LC layer 3. This will be described in detail.

The LC molecules 31 are pre-tilted by the slope members 331-333b in absence of the electric field and the pre-tilt directions of the LC molecules 31 determine the tilt directions of the LC molecules 31 upon application of the electric field, which are substantially perpendicular to the edges of the cutouts 91-92b and the oblique edges of the pixel electrodes 190.

Cutouts 91-92b and 71-72b of the electrodes 190 and 270 and the oblique edges of the pixel electrodes 190 distort the electric field to have a horizontal component that is also substantially perpendicular to the edges of the cutouts 91-92b and 71-72b and the oblique edges of the pixel electrodes 190.

In addition, the thickness variance of the slope members 331-333b distorts the equipotential lines of the electric field, and the distortion of the equipotential lines gives the tilting force, which also coincides with the tilt directions determined by the cutouts 91-92b and 71-72b.

Accordingly, the tilt directions of the LC molecules 31 far from the cutouts 91-92b and 71-72b and the chamfered edges of the pixel electrodes 190 are also determined to reduce the response time of the LC molecules 31.

A set of the cutouts 91-92b and 71-72b divides a pixel electrode 190 into a plurality of sub-areas and each sub-area has two major edges as shown in FIG. 3. The LC molecules 31 on each sub-area tilt in the aforementioned direction and the azimuthal distribution of the tilt directions are localized to four directions, thereby increasing the reference viewing angle of the LCD.

At least one of the cutouts 91-92b and 71-72b can be substituted with protrusions (not shown) or depressions (not shown). The protrusions are preferably made of organic or inorganic material and disposed on or under the field-generating electrodes 190 or 270.

The shapes and the arrangements of the cutouts 91-92b and 71-72b may be modified.

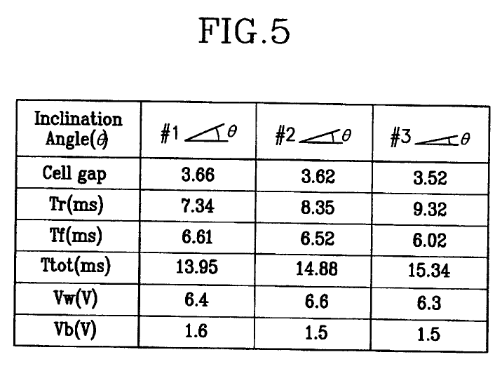

The response time Ttot of liquid crystal was measured for slope members having inclination angles of 1.9°, 1.8°, and 1.1°, which is illustrated as a table shown in FIG. 5. The response time Ttot of the liquid crystal includes a rising time Tr and a falling time Tf. The rising time Tr is the time for the LC molecules in absence of electric field to respond to an electric field generated by applying a maximum voltage Vw to a pixel electrode, and the falling time Tf is the time for the LC molecules subjected to the maximum electric field to return to their initial states after applying a minimum voltage Vb to the pixel electrode.

In the table shown in FIG. 5, “Cell gap” indicates the thickness of the LC layer 3, i.e., the distance between the panels 100 and 200.

As shown in FIG. 5, the measured response times are equal to 13.95 ms, 14.88 ms, and 15.34 ms, which are lower than 16 ms, while the response time for a conventional LCD without slope member was about 21-25 ms. In addition, the rising time Tr and the response time Ttot were reduced as the inclination angle of the slope member increases. The measured response times lower than 16 ms enable the realization of motion images since it is required to display 60 frames of images in one second for motion images.

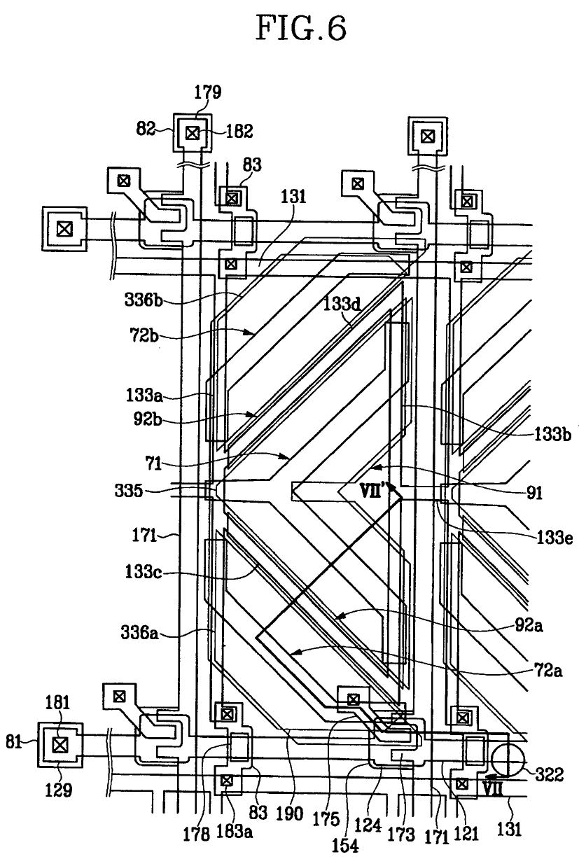

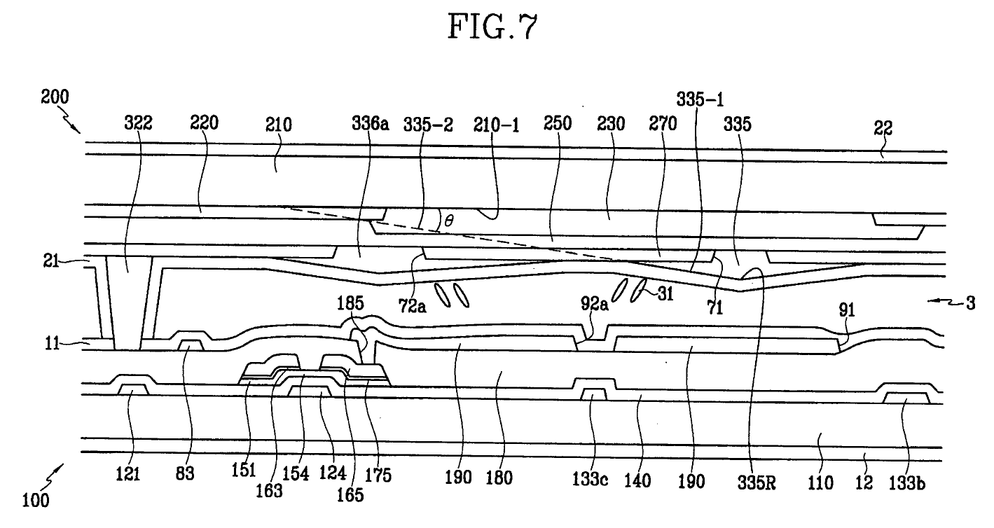

An LCD according to another embodiment of the present invention is described below in detail with reference to FIGS. 6 and 7.

FIG. 6 is a layout view of an LCD according to another embodiment of the present invention, and FIG. 7 is a sectional view of the LCD shown in FIG. 6 taken along line VII-VII′.

Referring to FIGS. 6 and 7, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 14.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b and 185 are provided at the passivation layer 180 and the gate insulating layer 140. A plurality of pixel electrodes 190 having a plurality of cutouts 91-92b, a plurality of overpasses 83, and a plurality of contact assistants 81 and 82 are formed on the passivation layer 180, and an alignment layer 11 is coated thereon.

Regarding the common electrode panel 200, a light blocking member 220, a plurality of color filters 230, an overcoat 250, a common electrode 270 having a plurality of cutouts 71-72b, and an alignment layer 21 are formed on an insulating substrate 210.

In contrast to the LCD shown in FIGS. 1-4, the common electrode panel 200 includes a plurality of sets of slope members 335, 336a and 336b and a plurality of columnar spacers 322 disposed on the common electrode 270 and the overcoat 250, while the TFT array panel 100 has no slope member and no columnar spacer. Like the slope members 331-333b and the spacers 320 in the prior embodiment, the slope members 335, 336a and 336b and the spacers 322 are preferably made from a single insulating film. Each set of the slope members 335-336b includes three slope members 335-336b facing a pixel electrode 190. Each of the slope members 335-336b has a planar shape of trapezoid or chevron having two primary edges and two secondary edges. The primary edges of the slope members 335-336b are parallel to oblique edges of the cutouts 71-72b and they are disposed opposite each other with respect to the cutouts 71-72b. The secondary edges of the slope members 335-336b are parallel to the gate lines 121 or the data lines 171. Each of the slope members 335-336b has a ridge and inclined surfaces. For example, see FIG. 7 where ridge 335R is indicated for slope member 335. The ridge is disposed approximately on and extends along center lines of the oblique portions of the cutouts 71-72b, and the inclined surfaces have heights decreasing from the ridge to the primary edges. As will be appreciated by reference to FIG. 7, the inclination angle θ of the inclined surface 335-1 relative to the surface 210-1 of the substrate 210 may be in a range of about 1-10 degrees. For explanation purposes, dashed line 335-2 extends from surface 335-1 to surface 210-1 of substrate 210 and the Greek letter theta (θ) is used to indicate the inclination angles.

In addition, the semiconductor stripes 151 of the TFT array panel 100 according to this embodiment have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Furthermore, the TFT array panel 100 further includes a plurality of semiconductor islands (not shown) and a plurality of ohmic contact islands (not shown) disposed thereon, which are disposed under the metal pieces 178.

A manufacturing method of the TFT array panel according to an embodiment simultaneously forms the data lines 171, the drain electrodes 175, the metal pieces 178, the semiconductors 151, and the ohmic contacts 161 and 165 using one photolithography process.

A photoresist pattern for the photolithography process has position-dependent thickness, and in particular, it has first and second portions with decreased thickness. The first portions are located on wire areas that will be occupied by the data lines 171, the drain electrodes 175, and the metal pieces 178 and the second portions are located on channel areas of TFTs.

The position-dependent thickness of the photoresist is obtained by several techniques, for example, by providing translucent areas on the exposure mask as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. In detail, once a photoresist pattern made of a reflowable material is formed by using a normal exposure mask only with transparent areas and opaque areas, it is subject to reflow process to flow onto areas without the photoresist, thereby forming thin portions.

As a result, the manufacturing process is simplified by omitting a photolithography step.

Many of the above-described features of the LCD shown in FIGS. 14 may be appropriate to the LCD shown in FIGS. 6 and 7.

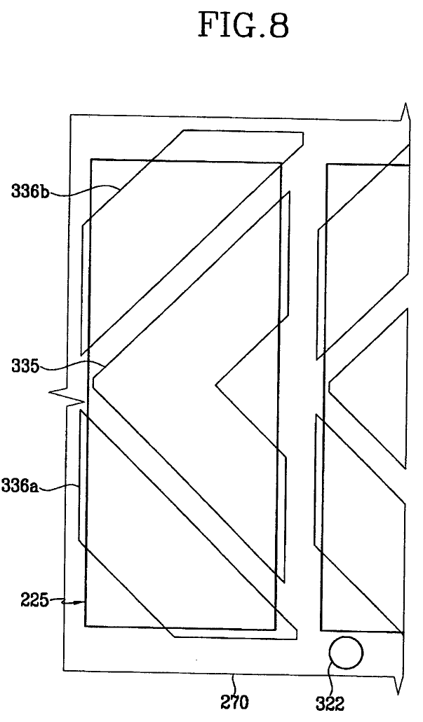

An LCD according to another embodiment of the present invention will be described in detail with reference to FIGS. 8-10.

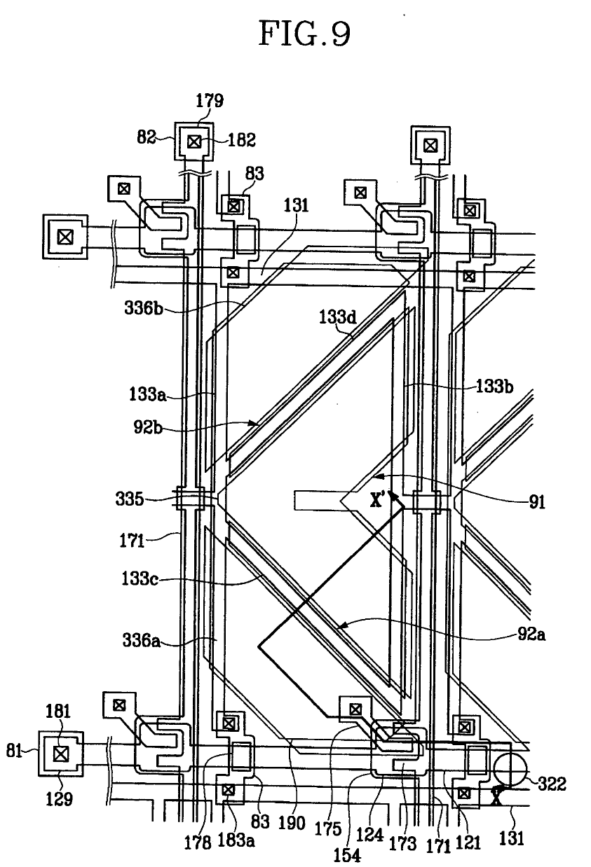

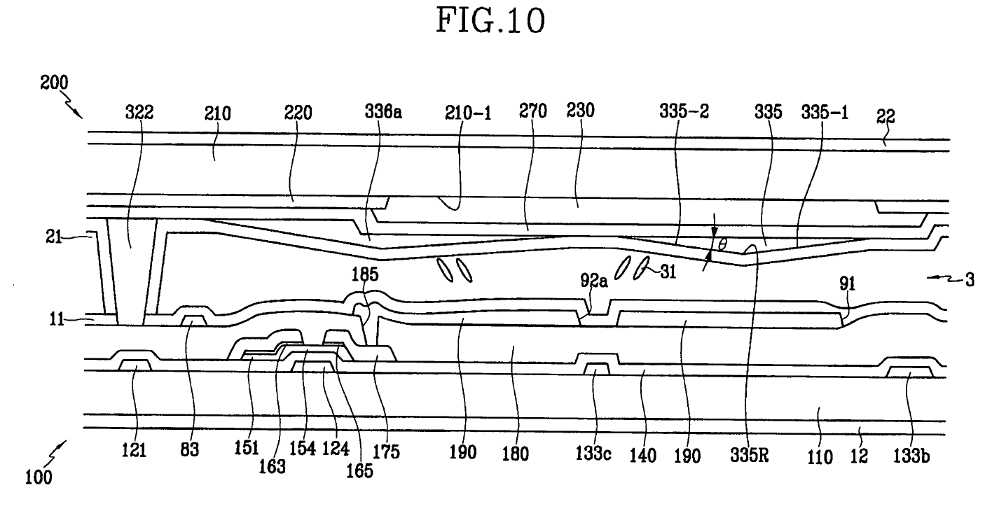

FIG. 8 is a layout view of a common electrode panel for an LCD according to another embodiment of the present invention, FIG. 9 is a layout view of an LCD including the TFT array panel shown in FIG. 1 and the common electrode panel shown in FIG. 8, and FIG. 10 is a sectional view of the LCD shown in FIG. 9 taken along line X-X′.

Referring to FIGS. 8-10, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 14.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165 and the gate insulating layer 140, and a passivation layer 180 is formed thereon. A plurality of contact holes 181, 182, 183a, 183b and 185 are provided at the passivation layer 180 and the gate insulating layer 140. A plurality of pixel electrodes 190 having a plurality of cutouts 91-92b, a plurality of overpasses 83, and a plurality of contact assistants 81 and 82 are formed on the passivation layer 180, and an alignment layer 11 is coated thereon.

Regarding the common electrode panel 200, a light blocking member 220 having a plurality of openings 225, a plurality of color filters 230, a common electrode 270, and an alignment layer 21 are formed on an insulating substrate 210.

In contrast to the LCD shown in FIGS. 14, the common electrode panel 200 includes a plurality of sets of slope members 335, 336a and 336b and a plurality of columnar spacers 322 disposed on the common electrode 270 and the overcoat 250, while the TFT array panel 100 has no slope member and no columnar spacer. Like the slope members 331-333b and the spacers 320, the slope members 335, 336a and 336b and the spacers 322 are preferably made from a single insulating film. Each set of the slope members 335-336b includes three slope members 335-336b facing a pixel electrode 190. Each of the slope members 335-336b has a planar shape of trapezoid or chevron having two primary edges and two secondary edges. The primary edges of the slope members 335-336b are parallel to edges of the cutouts 91-92b and the chamfered left edges of the pixel electrode 190 and they face the cutouts 91-92b or the chamfered edges of the pixel electrode 190. The secondary edges of the slope members 335-336b are parallel to the gate lines 121 or the data lines 171. Each of the slope members 335-336b has a ridge and inclined surfaces. For example in FIG. 10 see ridge 335R of slope member 335 and inclined surfaces 335-1 and 335-2. The ridge is substantially equidistant from the primary edges of the slope member 335-336b and it extends parallel to the primary edges. The inclined surfaces have heights decreasing from the ridge to the primary edges. The height of the ridge is in a range of about 0.5-2.0 microns and inclination angle θ of the inclined surfaces relative to surface 210-1 of the substrate 210 is in a range of about 1-10 degrees. It is preferable that a set of the slope members 335-336b occupy an area equal to or larger than half of a pixel electrode 190.

In addition, the common electrode 270 has no cutout and thus there is no overcoat although the omission of the overcoat is optional.

Although there is no cutout at the common electrode panel, the slope members 335-336b can sufficiently play a role of determining tilt directions along with the cutouts 91-92b of the pixel electrodes 190.

The omission of the cutout removes a lithography step for forming cutouts at the common electrode 270. In addition, the omission of the cutout prevents the accumulation of charge carriers at particular places, which may move to the polarizers 12 and 22 to damage the polarizers 12 and 22, thereby enabling to omit an electrostatic discharge (ESD) treatment for preventing the damage of the polarizers 12 and 22. Therefore, the omission of the cutout along with the omission of the overcoat remarkably reduces the cost for manufacturing the LCD.

Many of the above-described features of the LCD shown in FIGS. 14 may be appropriate to the TFT array panel shown in FIGS. 8-10.

The response time was measured for slope members that are provided on a common electrode panel 200 and have an inclination angle of about 2 degrees when the maximum and minimum voltages were 7V and 1V, respectively.

The rising time and the falling time were about 6.5 ms and about 6.3 ms and the response time was 12.8 ms. This shows that the rising time is remarkably decreased and is almost equal to the falling time. Accordingly, the asymmetry between the rising time and the falling time is removed.

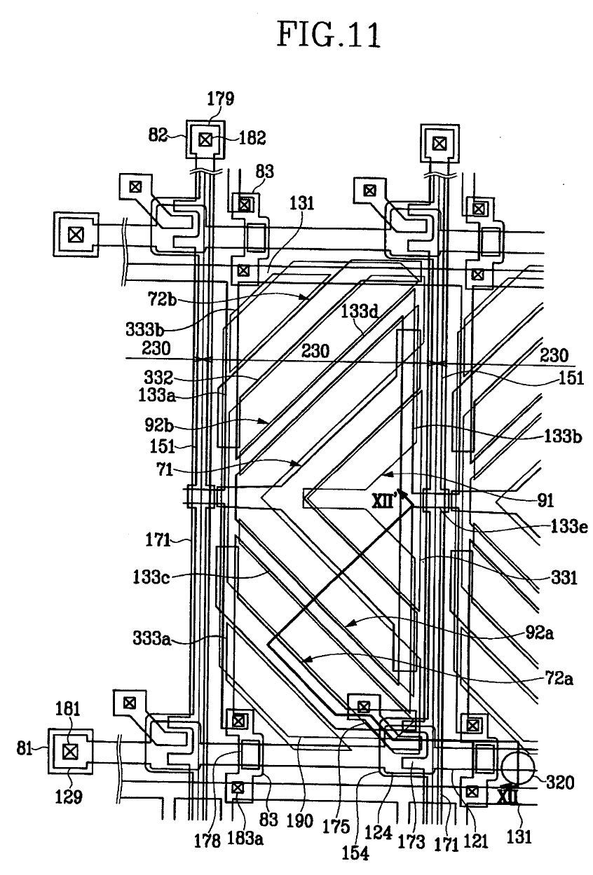

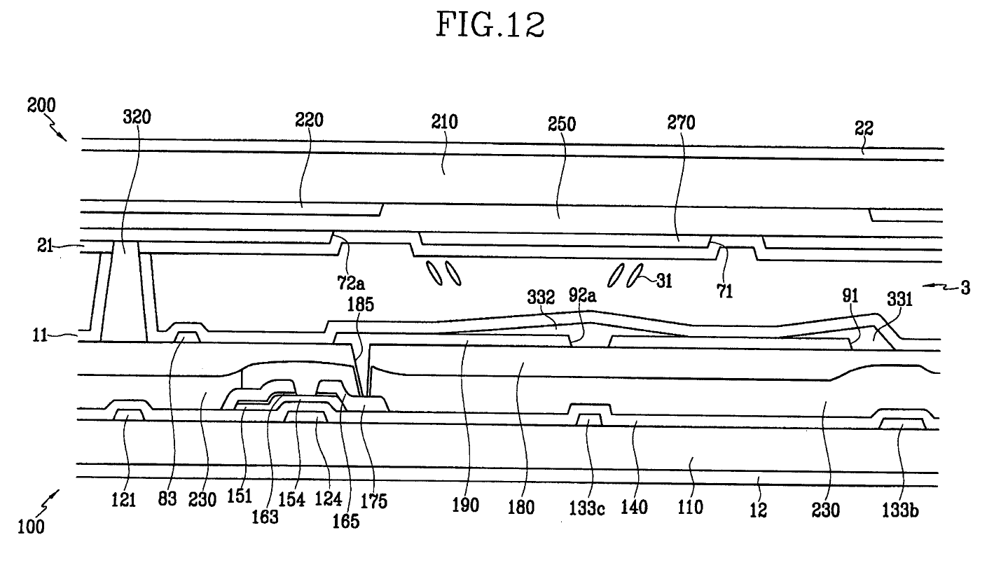

An LCD according to another embodiment of the present invention is described below in detail with reference to FIGS. 11 and 12.

FIG. 11 is a layout view of an LCD according to another embodiment of the present invention, and FIG. 12 is a sectional view of the LCD shown in FIG. 11 taken along line XII-XII′.

Referring to FIGS. 11 and 12, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 1-4.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165 and the gate insulating layer 140, and a passivation layer 180 is formed thereon. A plurality of contact holes 181, 182, 183a, 183b and 185 are provided at the passivation layer 180 and the gate insulating layer 140, and a plurality of pixel electrodes 190 having a plurality of cutouts 91-92b, a plurality of overpasses 83, and a plurality of contact assistants 81 and 82 are formed on the passivation layer 180. A plurality of slope members 331-333b and a plurality of columnar spacers 320 are formed on the pixel electrodes 190 and the passivation layer 180, and an alignment layer 11 is formed thereon.

Regarding the common electrode panel 200, a light blocking member 220, an overcoat 250, a common electrode 270 including a plurality of cutouts 71-72b, and an alignment layer 21 are formed on an insulating substrate 210.

In contrast to the LCD shown in FIGS. 1-4, the TFT array panel 100 in FIG. 12 includes a plurality of color filter stripes 230 disposed under the passivation layer 180, while the common electrode panel 200 has no color filter. The color filter stripes 230 extend along a longitudinal direction and edges of adjacent two of the color filter stripes 230 exactly match with each other on the data lines 171, but the color filters 230 may overlap each other to block the light leakage between the pixel electrodes 190, or may be spaced apart from each other. When the color filters 230 overlap each other, a light blocking member 220 disposed on a common electrode panel 200 may be omitted.

Many of the above-described features of the LCD shown in FIGS. 14 are the same as those in the TFT array panel shown in FIGS. 11 and 12.

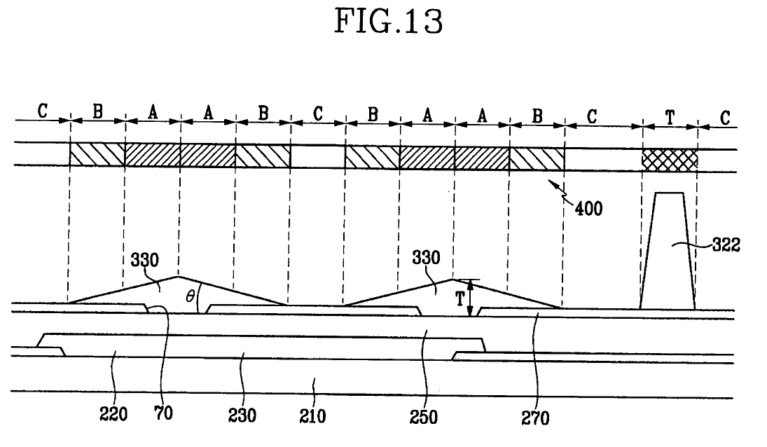

A manufacturing method for a common electrode panel including slope members according to an embodiment of the present invention is described in detail with reference to FIGS. 13 and 14.

FIG. 13 is a sectional view of a common electrode panel and a mask for forming slope members in an intermediate step of a manufacturing method thereof according to an embodiment of the present invention and FIG. 14 illustrates slits of the mask aligned with a slope member.

Referring to FIG. 13, a light blocking member 220, a plurality of color filters 230, and an overcoat 250 are formed in sequence on an insulating substrate 210. The light blocking member 220 is preferably made of organic material containing black pigment or Cr or Cr oxide, and the overcoat 250 is preferably made of inorganic or organic insulator. The color filters 230 may be formed, for example, by sequentially coating, light-exposing, and developing negative photosensitive organic material containing red, green, and blue pigments. Subsequently, an ITO or IZO layer is deposited on the overcoat 250 and pattern to form a common electrode 270 having a plurality of cutouts 70. The cutouts 70 may be omitted as described above with reference to FIGS. 8-10.

Next, a photosensitive organic insulating layer is coated on the common electrode 270, subjected to light exposure through a mask 400, and developed to form a plurality of slope members 330 and a plurality of columnar spacers 322. The mask 400 includes light transmitting areas C substantially fully transmitting incident light, translucent areas A and B partly transmitting incident light, and light blocking areas T substantially fully transmitting incident light. The translucent areas A and B face the slope members 330 and the light blocking areas T face the spacers 322. Referring to FIG. 14, the translucent areas A and B include a plurality of light blocking members 410 spaced apart from each other to define a plurality of slits 420 therebetween. The width of the slits 420 and the distance between the slits 420 are preferably lower than resolution of an exposer used in the light exposure. The light transmittance of the translucent areas A and B gradually increases from a center to edges of the translucent areas A and B. For example, in a translucent area A, the width of the light blocking members 410 is fixed in a range of about 1.0-2.5 microns and the width of the slits 420 gradually increases from a center to both edges of the translucent area A. On the contrary, the width of the slits 420 is fixed in a range of about 1.0-2.5 microns in a translucent area B and the width of the light blocking members 410 gradually decreases from a center to both edges of the translucent area B. The light blocking areas T may include the light blocking members 410 having widths larger than a predetermined value.

The above-described method can make a uniform inclination angle θ of the slope members 330 and to realize a uniform, reproducible manufacturing process. The thickness T of the slope members 330 preferably has a maximum value of about 1.5 microns in consideration of the transmittance of the slope members 330, the inclination angle of the slope members 330 is preferably in a range of about 1.2-3.0 degrees, and the width of the slope members 330 can be varied depending on the width of domains.

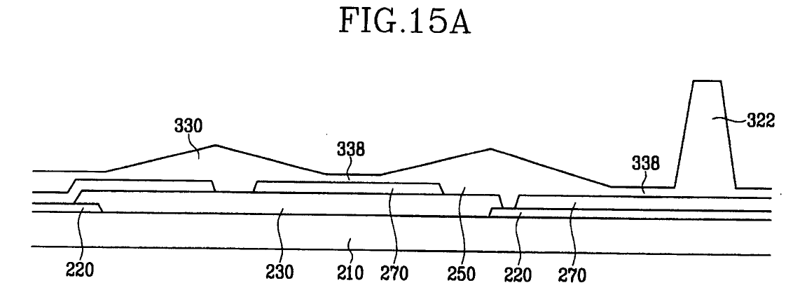

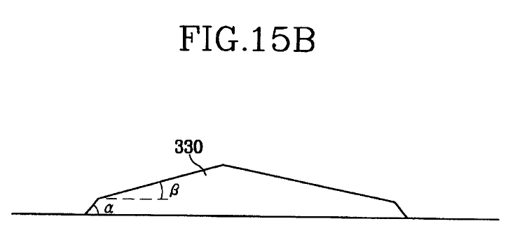

Slope members 330 and the spacers 322 may be connected through a plurality of ground portions 338 as shown in FIG. 15A, which illustrates a common electrode panel according to another embodiment of the present invention.

Referring to FIG. 15A, the ground portions 338 have flat surfaces covering the common electrode 270 and thus there is no overcoat 250. The ground portions 338 are thinner than the slope members 330 and the spacers 322. The structure shown in FIG. 15A can be formed by providing rough slits (not shown) on the light transmitting areas C of the mask 400 shown in FIG. 13 and it simplifies the manufacturing method thereof.

The slope members 330 may have a curved surface as shown in FIG. 15B, which illustrates a slope member according to another embodiment of the present invention.

Referring to FIG. 15B, the slope member 330 has an inclination angle β from its center to portions near its edges, but it has another inclination angle a larger than β near its edges. The inclination angles a and P are preferably equal to or lower than about 5 and 10 degrees, respectively.

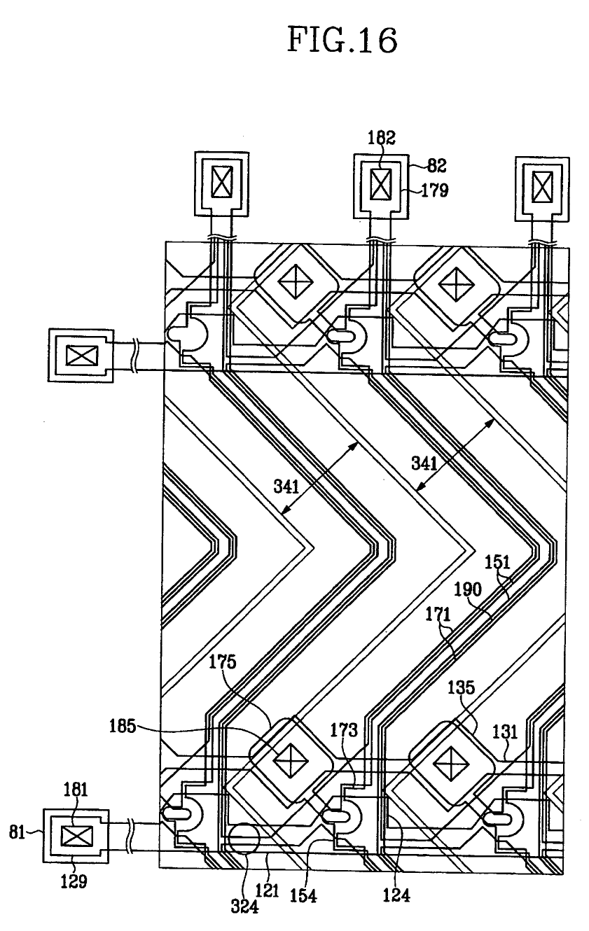

An LCD according to another embodiment of the present invention is described in detail with reference to FIGS. 16-20.

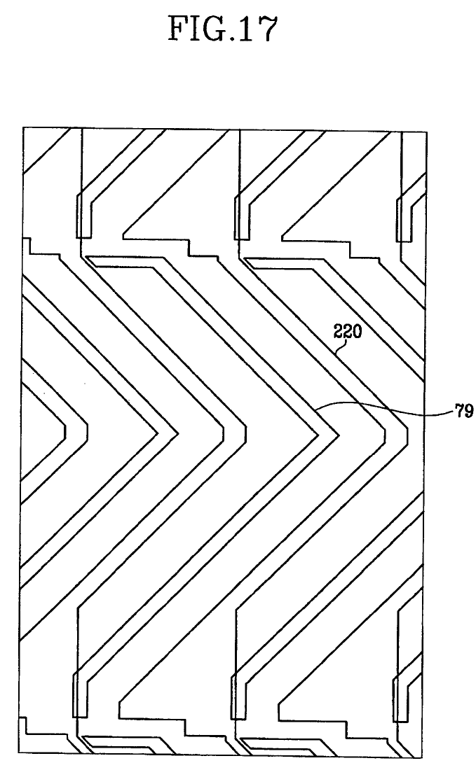

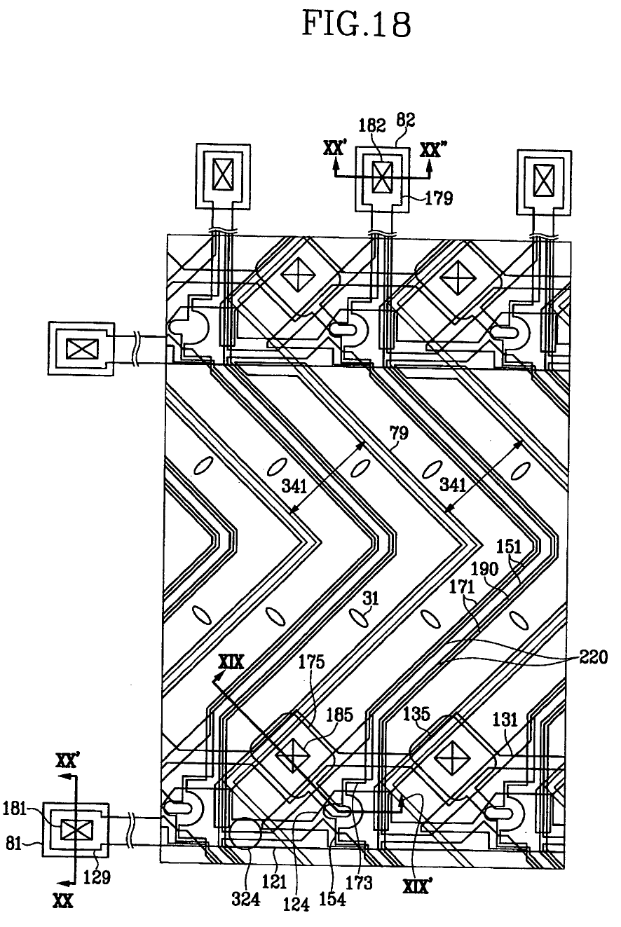

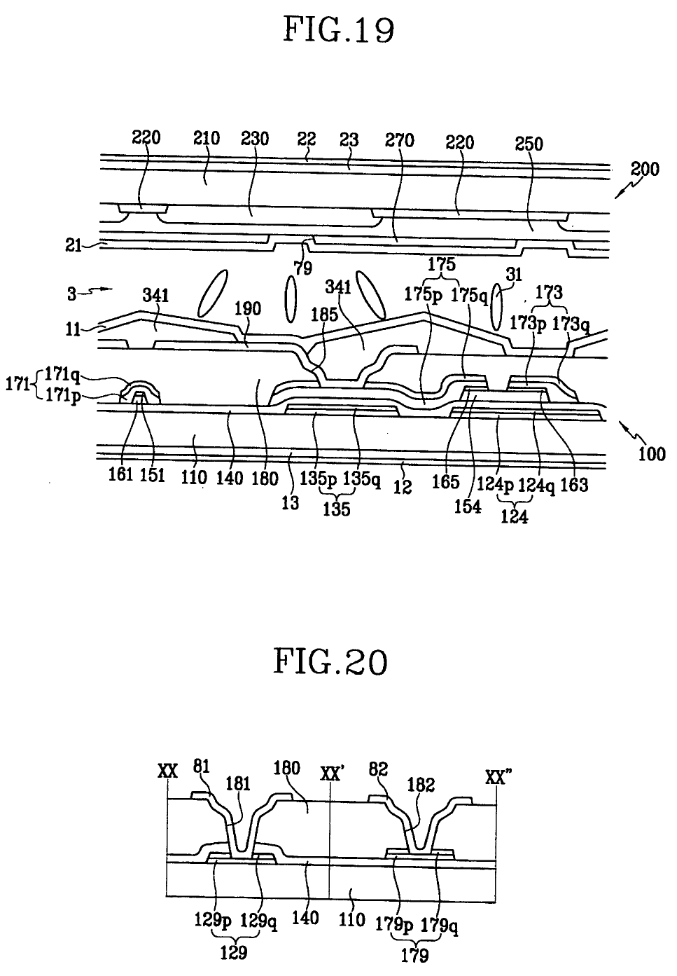

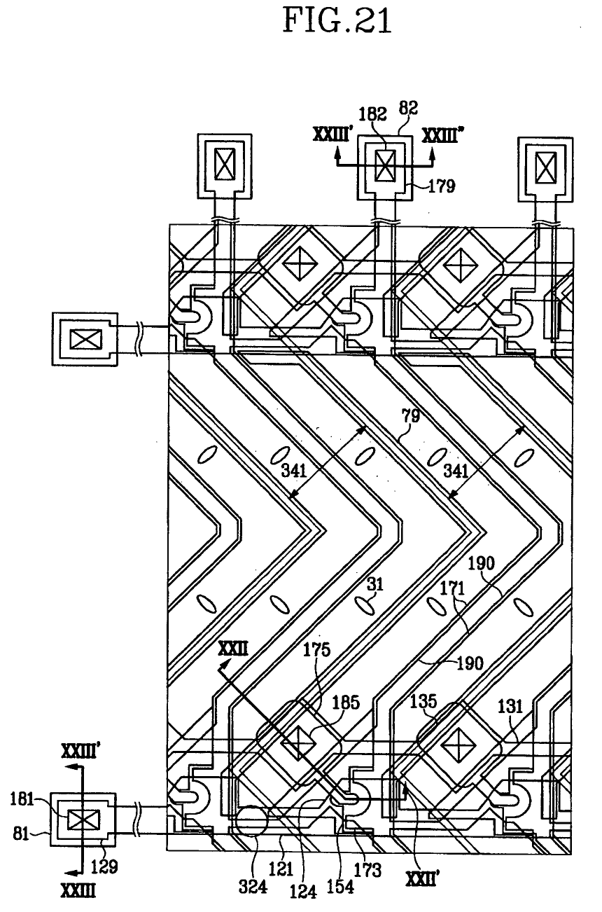

FIG. 16 is a layout view of a TFT array panel for an LCD according to an embodiment of the present invention, FIG. 17 is a layout view of a common electrode panel for an LCD according to an embodiment of the present invention, FIG. 18 is a layout view of an LCD including the TFT array panel shown in FIG. 16 and the common electrode panel shown in FIG. 17, FIG. 19 is a sectional view of the LCD shown in FIG. 18 taken along line XIX-XIX′, and FIG. 20 is a sectional view of the LCD shown in FIG. 18 taken along lines XX-XX′ and XX′-XX″.

An LCD according to an embodiment of the present invention includes a TFT array panel 100, a common electrode panel 200 facing the TFT array panel 100, and a LC layer 3 interposed between the TFT array panel 100 and the common electrode panel 200.

TFT array panel 100 shown in FIG. 19 is described in detail with reference to FIGS. 16,18-20.

A plurality of gate lines 121 and a plurality of storage electrode lines 131 are formed on an insulating substrate 110.

The gate lines 121 for transmitting gate signals extend substantially in a transverse direction and they are separated from each other. Each gate line 121 includes a plurality of projections forming a plurality of gate electrodes 124 and an end portion 129 having a large area for contact with another layer or an external device. The end portions 129 may not be provided when a gate driving circuit (not shown) is integrated on the substrate 110 such that the gate lines 121 in direct contact with the gate driving circuit.

Each storage electrode line 131 extends substantially in the transverse direction and includes a plurality of projections forming storage electrodes 135. Each storage electrode 135 has a shape of a diamond or a rectangle rotated by about 45 degrees and they are located close to the gate lines 121. The storage electrode lines 131 are supplied with a predetermined voltage such as a common voltage, which is applied to a common electrode 270 on the common electrode panel 200 of the LCD.

The gate lines 121 and the storage electrode lines 131 have a multi-layered structure including two films having different physical characteristics, a lower film and an upper film. The upper film is preferably made of low resistivity metal including Al containing metal, Ag containing metal, or Cu containing metal for reducing signal delay or voltage drop in the gate lines 121 and the storage electrode lines 131. On the other hand, the lower film is preferably made of material such as Mo containing metal, Cr, Ta, or Ti, which has good physical, chemical, and electrical contact characteristics with other materials such as ITO or IZO. A good exemplary combination of the lower film material and the upper film material is Cr and Al-Nd alloy. In FIGS. 19 and 20, the lower and the upper films of the gate electrodes 124 are indicated by reference numerals 124p and 124q, respectively, the lower and the upper films of the end portions 129 are indicated by reference numerals 129p and 129q, respectively, and the lower and the upper films of the storage electrodes 135 are indicated by reference numerals 135p and 135q, respectively. The upper film 252 of the end portions 129 of the gate lines 121 are removed at least in part to expose the lower films 129p.

The gate lines 121 and the storage electrode lines 131 may have a single layer structure or may include three or more layers.

In addition, the lateral sides of the gate lines 121 and the storage electrode lines 131 are inclined relative to a surface of the substrate 110, and the inclination angle thereof ranges about 30-80 degrees.

A gate insulating layer 140 preferably made of silicon nitride (SiNx) is formed on the gate lines 121 and the storage electrode lines 131.

A plurality of semiconductor stripes 151 preferably made of hydrogenated amorphous silicon (abbreviated as “a-Si”) or polysilicon are formed on the gate insulating layer 140. Each semiconductor stripe 151 extends substantially in the longitudinal direction while it is curved periodically. Each semiconductor stripe 151 has a plurality of projections 154 branched out toward the gate electrodes 124.

A plurality of ohmic contact stripes and islands 161 and 165 preferably made of silicide or n+ hydrogenated a-Si heavily doped with n type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are inclined relative to the surface of the substrate 110, and the inclination angles thereof are preferably in a range between about 30-80 degrees.

A plurality of data lines 171 and a plurality of drain electrodes 175 separated from each other are formed on the ohmic contacts 161 and 165 and the gate insulating layer 140.

The data lines 171 for transmitting data voltages extend substantially in the longitudinal direction and intersect the gate lines 121 and the storage electrode lines 131. Each data line 171 has an end portion 179 having a large area for contact with another layer or an external device and it includes a plurality of pairs of oblique portions and a plurality of longitudinal portions such that it curves periodically. A pair of oblique portions are connected to each other to form a chevron and opposite ends of the pair of oblique portions are connected to respective longitudinal portions. The oblique portions of the data lines 171 make an angle of about 45 degrees with the gate lines 121, and the longitudinal portions cross over the gate electrodes 124. The length of a pair of oblique portions is about one to nine times the length of a longitudinal portion, that is, it occupies about 50-90 percents of the total length of the pair of oblique portions and the longitudinal portion. A pair of oblique portions may be substituted with three or more oblique portions such that a part of a data line 171 between adjacent two longitudinal portions are curved twice or more.

Each drain electrode 175 includes a rectangular or rhombic expansion overlapping a storage electrode 135. The edges of the expansion of the drain electrode 175 are substantially parallel to the edges of the storage electrodes 135. Each longitudinal portion of the data lines 171 includes a plurality of projections such that the longitudinal portion including the projections forms a source electrode 173 partly enclosing an end portion of a drain electrode 175 disposed opposite the expansion. Each set of a gate electrode 124, a source electrode 173, and a drain electrode 175 along with a projection 154 of a semiconductor stripe 151 form a TFT having a channel formed in the semiconductor projection 154 disposed between the source electrode 173 and the drain electrode 175.

The data lines 171 and the drain electrodes 175 also include a lower film 171p and 175p preferably made of Mo, Mo alloy, Cr, Ta, or Ti and an upper film 171q and 175q located thereon and preferably made of Al containing metal, Ag containing metal, or Cu containing metal. In FIGS. 4 and 5, the lower and the upper films of the source electrodes 173 are indicated by reference numerals 173p and 173q, respectively, and the lower and the upper films of the end portions 179 of the data lines 171 are indicated by reference. numerals 179p and 179q, respectively. The upper films 179q, 175q of the end portions 179 of the data lines 171 and the drain electrodes 175 are removed at least in part to expose the lower films 179p and 175p.

Like the gate lines 121 and the storage electrode lines 131, the data lines 171 and the drain electrodes 175 have inclined lateral sides, and the inclination angles thereof range about 30-80 degrees.

The ohmic contacts 161 and 165 are interposed only between the underlying semiconductor stripes 151 and the overlying data lines 171 and the overlying drain electrodes 175 thereon and reduce the contact resistance therebetween.

A passivation layer 180 is formed on the data lines 171 and the drain electrodes 175, and exposed portions of the semiconductor stripes 151, which are not covered with the data lines 171 and the drain electrodes 175. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride and silicon oxide. The passivation layer 180 may have a double-layered structure including a lower inorganic film and an upper organic film in order to prevent the channel portions of the semiconductor stripes 151 from being in direct contact with organic material.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121. The above-described exposed portions of the lower films 129p, 179p and 175p are exposed through the contact holes 181, 182 and 185, respectively. The contact holes 181, 182 and 185 can have various shapes such as polygon or circle. The sidewalls of the contact holes 181, 182 and 185 are inclined with an angle of about 30-85 degrees or have stepwise profiles.

A plurality of pixel electrodes 190 and a plurality of contact assistants 81 and 82, which are preferably made of transparent conductive material such as ITO or IZO, are formed on the passivation layer 180. For a reflective LCD, the pixel electrodes 190 may be made of opaque reflective material such as Ag or Al.

Each pixel electrode 190 is located substantially in an area enclosed by the data lines 171 and the gate lines 121, and thus it also forms a chevron. The pixel electrodes 190 cover the storage electrode lines 131 including the storage electrodes 135 and the expansions of the drain electrodes 175 and have chamfered edges substantially parallel to edges of the storage electrodes 135 that are close to the chamfered edges.

The capacitances of the storage capacitors implemented by overlapping the pixel electrodes 190 with the storage electrode lines 131, i.e., the storage capacitances are increased by providing the projections (i.e., the storage electrodes) 135 at the storage electrode lines 131, elongating the drain electrodes 175 connected to the pixel electrodes 190, and providing the expansions at the drain electrodes 175 overlapping the storage electrodes 135 of the storage electrode lines 131 for decreasing the distance between the terminals and increasing the overlapping areas.

The pixel electrodes 190 overlap the data lines 171 as well as the gate lines 121 to increase aperture ratio.

The contact assistants 81 and 82 are connected to the exposed end portions 129 of the gate lines 121 and the exposed end portions 179 of the data lines 171 through the contact holes 181 and 182, respectively. The contact assistants 81 and 82 protect the exposed portions 129 and 179 and complement the adhesion between the exposed portions 129 and 179 and external devices. The contact assistants 81 and 82 are connected to external devices through anisotropic conductive films (ACF) (not shown), etc.

The contact assistants 81 may play a role connecting the gate lines 121 and metal layers of a gate driving circuit, if it is integrated on the TFT array panel. Similarly, the contact assistants 82 may play a role connecting the data lines 171 and metal layers of a data driving circuit, if it is integrated on the TFT array panel 100.

A plurality of slope members 341 and a plurality of columnar spacers 324 preferably made of insulator are formed on the pixel electrodes 190 and the passivation layer 180. Each of the slope members 341 has primary edges parallel to the edges of the pixel electrodes 190 and disposed on an imaginary center line bisecting a pixel electrode 190 into left and right halves and secondary edges parallel to the gate lines 121 such that it has a planar shape of chevron. Each of the slope members 341 has a ridge disposed on a 15 data line 171 and extending therealong and inclined surfaces having heights decreasing from the ridge to the primary edges.

Since the slope members 341 are centered at the data lines 171 and the light blocking members 220, the decrease of light transmittance that may be generated by the slope members 341 may be reduced. In addition, the slope members 341 reduce electric field generated by the data lines 171 that may distort the orientations of the LC molecules 31 to generate spots. Accordingly, the alignment margins between the data lines 171 and the pixel electrodes 190 can be increased.

Finally, an alignment layer 11 that may be homeotropic is formed on the slope members 341.

The description of the common electrode panel 200 follows with reference to FIGS. 17-19.

A light blocking member 220 is formed on an insulating substrate 210 such as transparent glass and it includes a plurality of oblique portions facing the oblique portions of the data lines 171 and a plurality of right-angled-triangular portions facing the TFTs and the longitudinal portions of the data lines 171 such that the light blocking member 220 prevents light leakage between the pixel electrodes 190 and defines open areas facing the pixel electrodes 190. Each of the triangular portions of the light blocking member 220 has a hypotenuse parallel to a chamfered edge of a pixel electrode 190.

A plurality of color filters 230 are formed on the substrate 210 and the light blocking member 220 and it is disposed substantially in the open areas defined by the light blocking member 220. The color filters 230 disposed in adjacent two data lines 171 and arranged in the longitudinal direction may be connected to each other to form a stripe. Each color filter 230 may represent one of three primary colors such as red, green and blue colors.

An overcoat 250 preferably made of organic material is formed on the color filters 230 and the light blocking member 220. The overcoat 250 protects the color filters 230 and has a flat top surface.

A common electrode 270 preferably made of transparent conductive material such as ITO and IZO is formed on the overcoat 250. The common electrode 270 is supplied with the common voltage and it has a plurality of chevron-like cutouts 79. Each cutout 79 includes a pair of oblique portions connected to each other, a transverse portion connected to one of the oblique portions, and a longitudinal portion connected to the other of the oblique portions. The oblique portions of the cutout 79 extend substantially parallel to the oblique portions of the data lines 171 and face a pixel electrode 190 so that they may bisect the pixel electrode 190 into left and right halves. The transverse and the longitudinal portions of the cutout 79 are aligned with transverse and longitudinal edges of the pixel electrode 190, respectively, and they make obtuse angles with the oblique portions of the cutout 79. The cutouts 79 are provided for controlling the tilt directions of the LC molecules 31 in the LC layer 3 and preferably have a width in a range between about 9-12 microns. The cutouts 79 may be substituted with protrusions formed on or under the common electrode 270, preferably made of organic material, and preferably having width ranging about 5 microns to 10 microns.

An alignment layer 21 that may be homeotropic is coated on the common electrode 270.

A pair of polarizers 12 and 22 are provided on outer surfaces of the panels 100 and 200 such that their transmissive axes are crossed and one of the transmissive axes, for example, the transmissive axis of the polarizer 12 provided on the TFT array panel 100 is parallel to the gate lines 121. The polarizer 12 may be omitted for a reflective LCD.

The LCD further includes retardation films 13 and 23 interposed between the panels 100 and 200 and the polarizers 12 and 22. The retardation films 13 and 23 have birefringence and compensate the retardation of the LC layer 3 in a reversed manner. The retardation films 13 and 23 may include uniaxial or biaxial optical films, and in particular, they may include negative uniaxial optical films.

The LCD may further include a backlight unit for providing light for the polarizers 12 and 22, the panels 100 and 200, and the LC layer 3.

The alignment layers 11 and 21 may be homogeneous alignment layers.

The LC layer 3 has negative dielectric anisotropy and the LC molecules 31 in the LC layer 3 are aligned such that their long axes are vertical to the surfaces of the panels in absence of electric field. Accordingly, incident light cannot pass the crossed polarization system 12 and 22.

Upon application of the common voltage to the common electrode 270 and a data voltage to the pixel electrodes 190, a primary electric field substantially perpendicular to the surfaces of the panels is generated. The LC molecules 31 tend to change their orientations in response to the electric field such that their long axes are perpendicular to the field direction. In the meantime, the cutouts 79 of the common electrode 270 and the edges of the pixel electrodes 190 distort the primary electric field to have a horizontal component which determines the tilt directions of the LC molecules 31. The horizontal component of the primary electric field is perpendicular to the edges of the cutouts 79 and the edges of the pixel electrodes 190. The horizontal components of the primary electric field at opposite edges of a cutout are antiparallel.

Accordingly, four sub-regions having different tilt directions, which are partitioned by edges of a pixel electrode 190, a cutout 79 bisecting the pixel electrode 190, and an imaginary transverse center line passing through the meeting point of the oblique portions of the cutout 79, are formed in a pixel region of the LC layer 3, which are located on the pixel electrode 190. Each sub-region has two major edges defined by the cutout 79 and an oblique edge of the pixel electrode 190, respectively, which are spaced apart preferably from about 10 microns to about 30 microns. The number of the sub-regions in a pixel region is preferably four if the planar area of the pixel region is smaller than about 100×300 square microns, and, if not, it is preferably four or eight. The number of the sub-regions can be varied by changing the number of the cutouts 79 of the common electrode 270, by providing cutouts at the pixel electrodes 190, or by changing the number of curved points of the edges of the pixel electrodes 190. The sub-regions are classified into a plurality of, preferably four, domains based on the tilt directions.

The direction of a secondary electric field due to the voltage difference between the pixel electrodes 190 is perpendicular to the edges of the cutouts 79. Accordingly, the field direction of the secondary electric field coincides with that of the horizontal component of the primary electric field. Consequently, the secondary electric field between the pixel electrodes 190 enhances the determination of the tilt directions of the LC molecules 31.

Since the LCD performs inversion such as dot inversion and column inversion, adjacent pixel electrodes are supplied with data voltages having opposite polarity with respect to the common voltage and thus a secondary electric field between the adjacent pixel electrodes 190 is almost always generated to enhance the stability of the domains.

A method of manufacturing the TFT array panel shown in FIGS. 16-20 according to an embodiment of the present invention is described below in detail.

A lower conductive film preferably made of Cr, Mo, or Mo alloy and an upper conductive film preferably made of Al containing metal or Ag containing metal are sputtered in sequence on an insulating substrate 110 and they are wet or dry etched in sequence to form a plurality of gate lines 121 including gate electrodes 124 and end portions 129, and a plurality of storage electrode lines 131 including storage electrodes 135. The lower and the upper films of the gate electrodes 124 are indicated by reference numerals 124p and 124q, respectively, the lower and the upper films of the end portions 129 are indicated by reference numerals 129p and 129q, respectively, and the lower and the upper films of the storage electrodes 135 are indicated by reference numerals 135p and 135q, respectively.

After sequential deposition of a gate insulating layer 140 with thickness of about 1,500-5,000 Å, an intrinsic a-Si layer with thickness of about 500-2,000 Å, and an extrinsic a-Si layer with thickness of about 300-600 Å, the extrinsic a-Si layer and the intrinsic a-Si layer are photo-etched to form a plurality of extrinsic semiconductor stripes and a plurality of intrinsic semiconductor stripes 151 including projections 154 on the gate insulating layer 140.

Subsequently, two conductive films including a lower conductive film and an upper conductive film and having a thickness of 1,500-3,000 Å are sputtered in sequence and patterned to form a plurality of date lines 171 including source electrodes 173 and end portions 179, and a plurality of drain electrodes 175. The lower conductive film is preferably made of Cr, Mo, or Mo alloy, and the upper conductive film is preferably made of Al containing metal or Ag containing metal. The lower and the upper films of the data lines 171 are indicated by reference numerals 171p and 171q, respectively, the lower and the upper films of the source electrodes 173 are indicated by reference numerals 173p and 173q, respectively, the lower and the upper films of the drain electrodes 175 are indicated by reference numerals 175p and 175q, respectively, and the lower and the upper films of the end portions 179 of the data lines 171 are indicated by reference numerals 179p and 179q, respectively.

Thereafter, portions of the extrinsic semiconductor stripes, which are not covered with the data lines 171 and the drain electrodes 175, are removed to complete a plurality of ohmic contact stripes 161 including projections 163 and a plurality of ohmic contact islands 165 and to expose portions of the intrinsic semiconductor stripes 151. Oxygen plasma treatment preferably follows in order to stabilize the exposed surfaces of the semiconductor stripes 151.

A passivation layer 180 made of a photosensitive organic insulator is coated and exposed to light through a photo-mask (not shown). The passivation layer 180 is then developed to form a plurality of contact holes 182 and 185 exposing the end portions 179 of the data lines 171 and the drain electrodes 175, respectively, and to form upper portions of a plurality of contact holes 181 exposing portions of the gate insulating layer 140 disposed on the end portions 129 of the gate lines 121.

After removing the exposed portions of the gate insulating layer 140 to expose the underlying portions of the end portions 129 of the gate lines 121, the exposed portions of the upper conductive films 175q, 179q and 129q of the drain electrodes 175, the end portions 179 of the data lines 171, and the end portions 129 of the gate lines 121 are removed to expose underlying portions of the lower conductive films 175p, 179p and 129p of the drain electrodes 175, the end portions 179 of the data lines 171, and the end portions 129 of the gate lines 121.

Next, a plurality of pixel electrodes 190 and a plurality of contact assistants 81 and 82 are formed on the passivation layer 180 and on the exposed portions of the lower conductive films 175p, 129p and 179p of the drain electrodes 175, the end portions 129 of the gate lines 121, and the end portions 179 of the data lines 171 by sputtering and photo-etching an IZO or ITO layer with thickness of about 400-500 Å.

Finally, a positive photosensitive organic insulating layer is coated on the common electrode 270, subjected to light exposure through a mask (not shown) having light transmitting areas, translucent areas, and light blocking areas, and developed to form a plurality of slope members 341 and a plurality of columnar spacers 324.

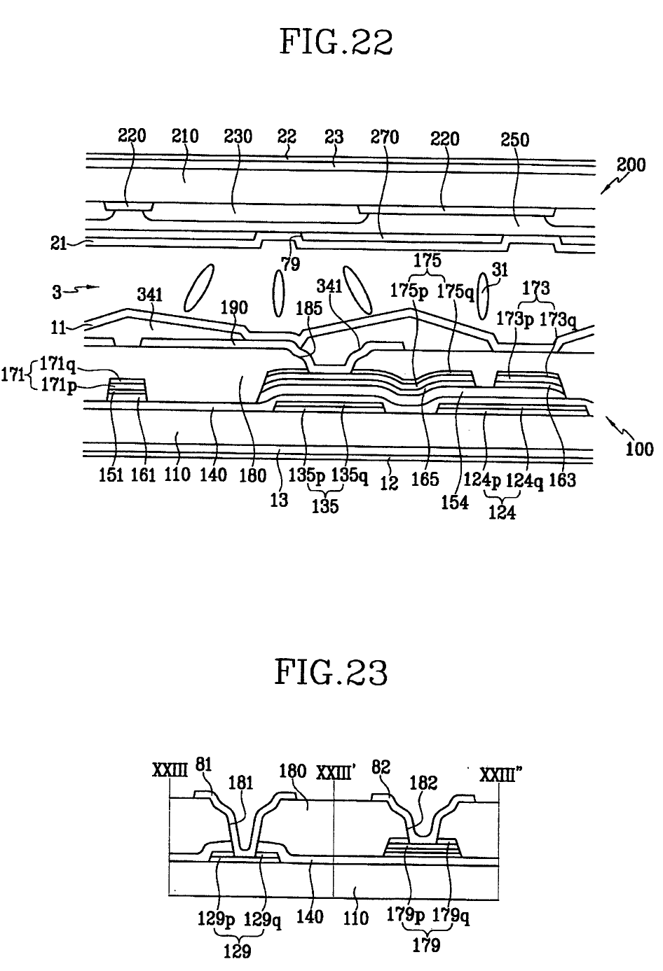

An LCD according to another embodiment of the present invention will be described in detail with reference to FIGS. 21-23.

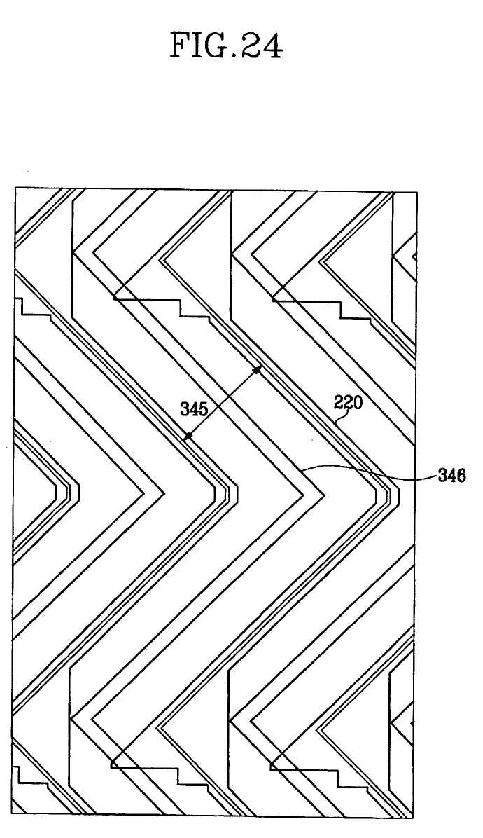

FIG. 21 is a layout view of an LCD according to another embodiment of the present invention, and FIGS. 22 and 23 are sectional views of the LCD shown in FIG. 21 taken along lines XXII-XXII′ and XXIII-XXIII′, respectively.

Referring to FIGS. 21-23, an LCD according to this embodiment also includes a TFT array panel 100, a common electrode panel 200, a LC layer 3 interposed between the panels 100 and 200, and a pair of polarizers 12 and 22 and a pair of retardation films 13 and 23 attached on outer surfaces of the panels 100 and 200.

Layered structures of the panels 100 and 200 according to this embodiment are almost the same as those shown in FIGS. 16-20.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179 and a plurality of drain electrodes 175 are formed on the ohmic contacts 161 and 165, and a passivation layer 180 is formed thereon. A plurality of contact holes 181, 182 and 185 are provided at the passivation layer 180 and the gate insulating layer 140 and a plurality of pixel electrodes 190 and a plurality of contact assistants 81 and 82 are formed on the passivation layer 180. A plurality of slope members 341 and a plurality of columnar spacers 324 are formed on the pixel electrodes 190 and the passivation layer 180 and an alignment layer 11 is coated thereon.

Regarding the common electrode panel 200, a light blocking member 220, a plurality of color filters 230, an overcoat 250, a common electrode 270 having a plurality of cutouts 79, and an alignment layer 21 are formed on an insulating substrate 210.

In contrast to the LCD shown in FIGS. 16-20, the semiconductor stripes 151 of the TFT array panel 100 according to this embodiment have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Many of the above-described features of the LCD shown in FIGS. 16-20 may be appropriate to the TFT array panel shown in FIGS. 21-23.

An LCD according to another embodiment of the present invention will be described in detail with reference to FIGS. 24-26.

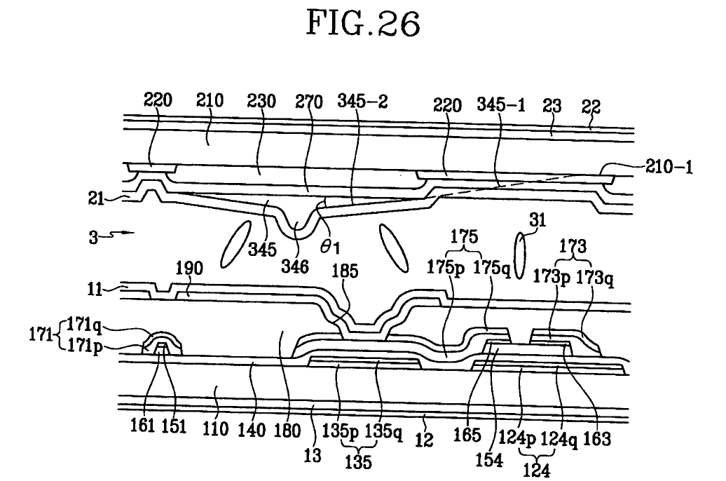

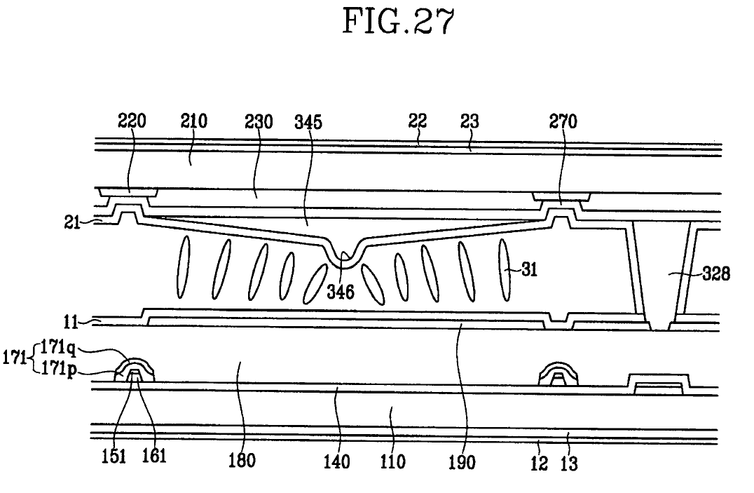

FIG. 24 is a layout view of a common electrode panel for an LCD according to another embodiment of the present invention, FIG. 25 is a layout view of an LCD including the TFT array panel shown in FIG. 16 and the common electrode panel shown in FIG. 24, and FIGS. 26 and 27 are sectional views of the LCD shown in FIG. 25 taken along lines XXVI-XXVI′ and XXVII-XXVII′, respectively.

Referring to FIGS. 24-27, an LCD according to this embodiment also includes a TFT array panel 100, a common electrode panel 200, a LC layer 3 interposed between the panels 100 and 200, and a pair of polarizers 12 and 22 and a pair of retardation films 13 and 23 attached on outer surfaces of the panels 100 and 200.

Layered structures of the panels 100 and 200 according to this embodiment are almost the same as those shown in FIGS. 16-20.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179 and a plurality of drain electrodes 175 are formed on the ohmic contacts 161 and 165, and a passivation layer 180 is formed thereon. A plurality of contact holes 181, 182 and 185 are provided at the passivation layer 180 and the gate insulating layer 140. A plurality of pixel electrodes 190 and a plurality of contact assistants 81 and 82 are formed on the passivation layer 180, and an alignment layer 11 is coated thereon.

Regarding the common electrode panel 200, a light blocking member 220, a plurality of color filters 230, a common electrode 270, and an alignment layer 21 are formed on an insulating substrate 210.

In contrast to the LCD shown in FIGS. 16-20, the common electrode panel 200 includes a plurality of slope members 345 and a plurality of columnar spacers 320 disposed on the common electrode 270, while the TFT array panel 100 has no slope member and no spacer and the common electrode panel 200 has no cutout. Like the slope members 341 and the spacers 324 in the prior embodiment, slope members 345 and the spacers 328 are preferably made of insulator. Each of the slope members 345 has primary edges extending parallel to the data lines 171 and disposed on the data lines 171 and secondary edges parallel to the gate lines 121 such that it has a planar shape of chevron. Each of the slope members 345 has a protruding curvilinear ridge 346, which is disposed approximately on an imaginary center line bisecting a pixel electrode 190 into left and right halves and extends therealong, and inclined surfaces that have heights decreasing from the ridge 346 to the primary edges. It is noted that most portions of primary edges of the slope members 345 coincide with the light blocking members 220 in the figures.

The protruding curvilinear ridges 346 are substituted for the cutouts 79 shown in FIGS. 17-19 and serve as tilt direction determining members for determining the tilt directions of the LC molecules 31. The ridges 346 preferably have width of about 5-10 microns. The inclination angle θ₁ of the inclined surfaces 345-2 relative to the surface of the substrate 210 is in a range of about 0.5-20 degrees. This inclination angle θ₁ is indicated through the use of dashed line 345-1 which extends from inclination surface 345-2 to surface 210-1 of substrate 210. The cell gap between the panels 100 and 200, i.e., the thickness of the LC layer 3 varies from about 0.5 microns to about 2.0 microns.

In addition, the common electrode 270 has no overcoat.

Many of the above-described features of the LCD shown in FIGS. 16-20 are common with the TFT array panel shown in FIGS. 23-27.

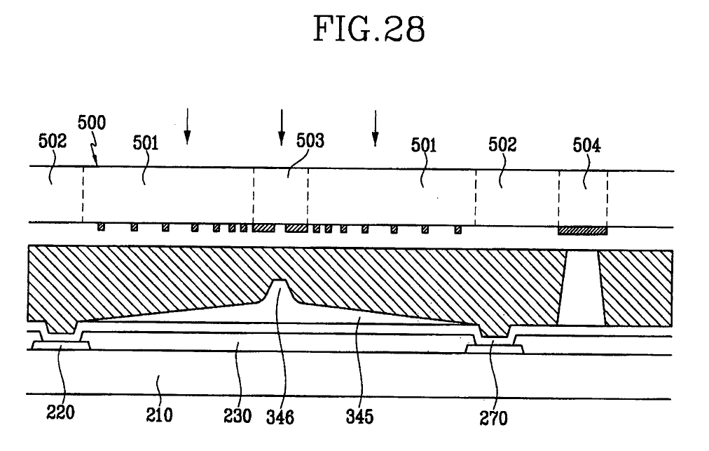

A method of manufacturing the common electrode panel shown in FIGS. 23-27 is described in detail with reference to FIG. 28.

FIG. 28 is a sectional view of a common electrode panel shown in FIGS. 23-27 and a mask for forming slope members in an intermediate step of a manufacturing method thereof according to an embodiment of the present invention.

Referring to FIG. 28, a light blocking member 220 preferably made of a Cr film and a Cr oxide film, a plurality of color filters 230, and a common electrode 270 are formed in sequence on an insulating substrate 210.

Next, a thick photosensitive organic insulating layer is coated on the common electrode 270, subjected to light exposure through a mask 500, and developed to form a plurality of slope members 345 including protruding ridge lines 346 and a plurality of columnar spacers 328. The mask 500 includes light blocking areas 504 facing the spacers 328, light transmitting areas 503, and translucent areas 501 and 502 having a plurality of slits and facing the slope members 345. The width of the slits increases from the areas 502 for the ridge lines 346 to the light transmitting areas 503. However, the distance between the slits may decrease from the translucent areas 502 for the ridge lines 346 to the light transmitting areas 503.

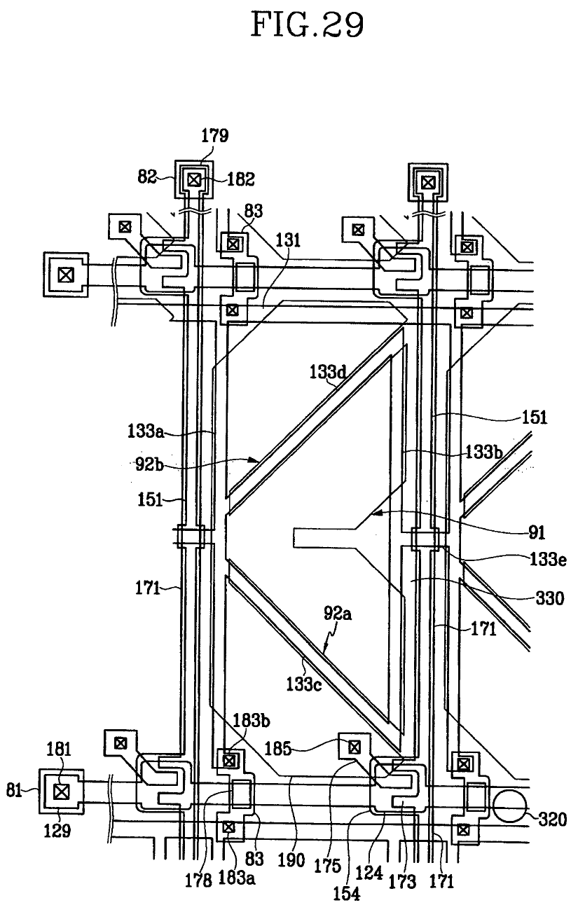

An LCD according to another embodiment of the present invention is described below in detail with reference to FIGS. 29, 30, 31 and 31.

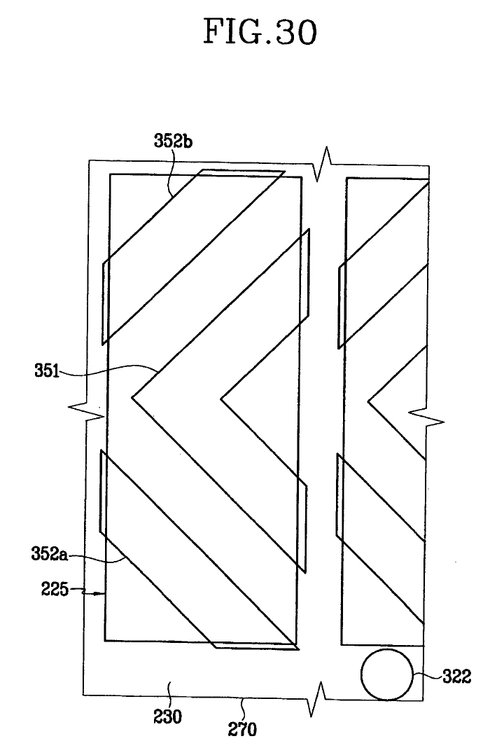

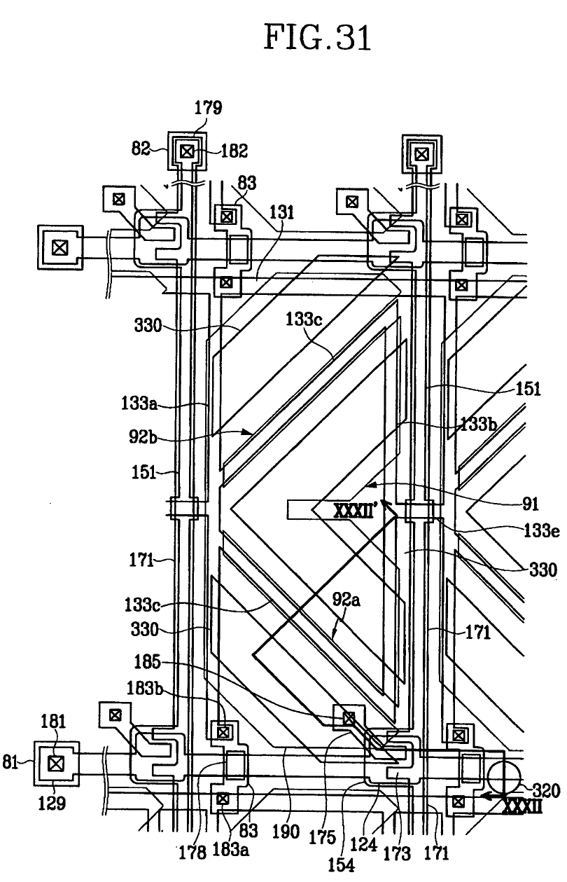

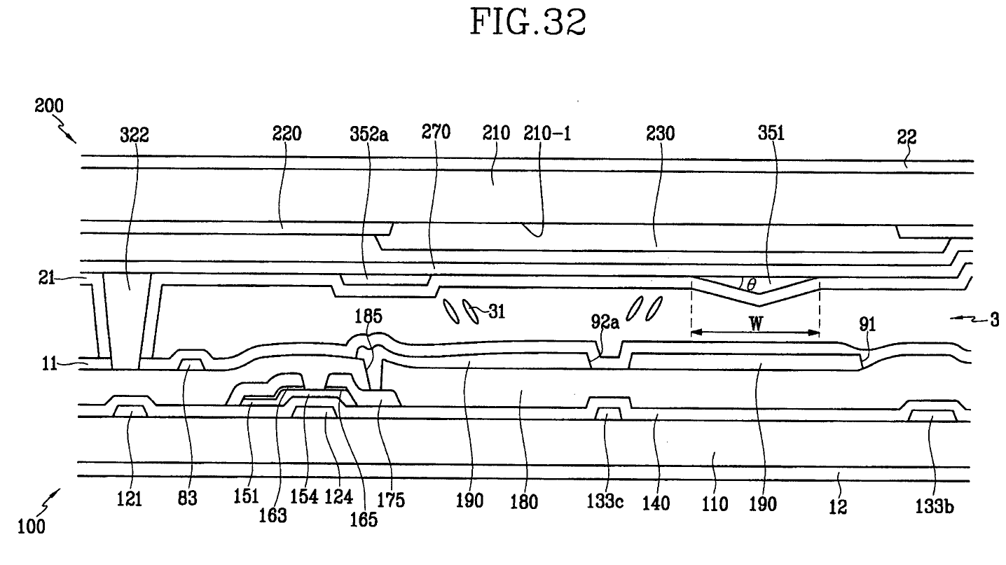

FIG. 29 is a layout view of a TFT array panel of an LCD according to another embodiment of the present invention, FIG. 30 is a layout view of a common electrode panel of an LCD according to another embodiment of the present invention, FIG. 31 is a layout view of an LCD including the TFT array panel shown in FIG. 29 and the common electrode panel shown in FIG. 30, and FIG. 32 is a sectional view of the LCD shown in FIG. 31 taken along line XXXII-XXXII′.

Referring to FIGS. 29-32, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are very similar to those shown in FIGS. 8-10.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b and 185 are provided at the passivation layer 180 and the gate insulating layer 140. A plurality of pixel electrodes 190 having a plurality of cutouts 91-92b, a plurality of overpasses 83, and a plurality of contact assistants 81 and 82 are formed on the passivation layer 180, and an alignment layer 11 is coated thereon.

Regarding the common electrode panel 200, a light blocking member 220, a plurality of color filters 230, a common electrode 270, a plurality of slope members 351, 352a and 352b, a plurality of columnar spacers 322, and an alignment layer 21 are formed on an insulating substrate 210.

In contrast to the LCD shown in FIGS. 8-10, the width of the slope members 351-352b indicated by W in FIG. 32 is small and thus the distance between edges of adjacent slope members 351-352b is much smaller than the width of the cutouts 91-92b. The area occupied by the slope members 351-352b is preferably equal to or smaller than about a half of the area of the pixel electrodes 190 and preferably in a range of about 2547.5% of the area of the pixel electrodes 190. The height of the peak of the ridge as measured from the base of the slope member for each of the slope members 351-352b is preferably smaller than about 3 microns, and more preferably in a range of about 0.8-1.2 microns, and the inclination angle θ (FIG. 32) of the inclined surfaces relative to the surface 210-1 of the substrate 210 is preferably in a range of about 1-10 degrees. The dielectric constant of the slope members 351-352b is preferably equal to or less than about 10.

Since the slope members 351-352b change the cell gap (i.e., the thickness of the LC layer 3) and the strength of the electric field in the LC layer 3, the LC molecules 31 on the slope members 351-352b are subjected to the tilting force different from the LC molecules 31 on other areas where there is no slope member. Therefore, the transmittance on each sub-area has difference values depending on the position, thereby improving visibllity.

In addition, there is an overcoat 250 between the color filters 230 and the common electrode 270 although it is optional.

The spacers 322 may be made of a different layer than the slope members 351-352b.

Many of the above-described features of the LCD shown in FIGS. 8-10 are common to the LCD shown in FIGS. 29-32.

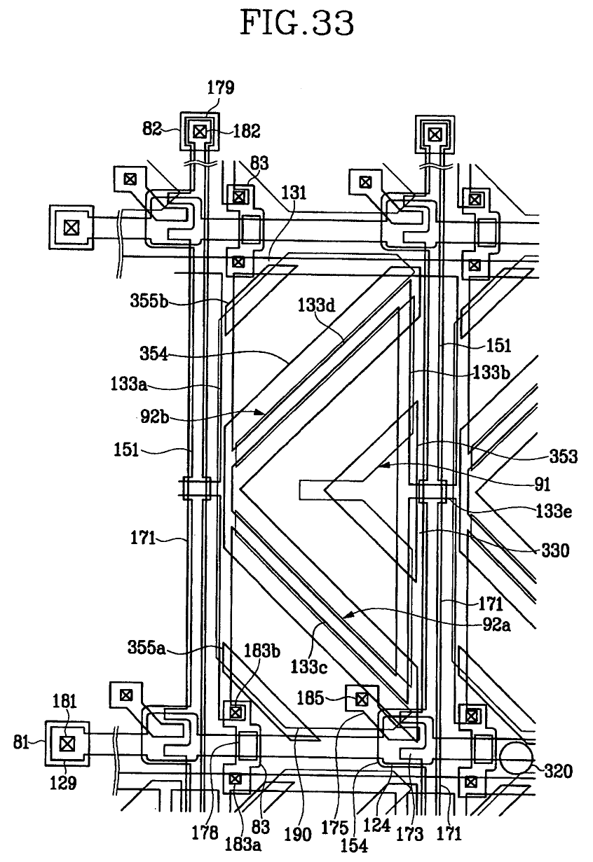

An LCD according to another embodiment of the present invention will be described in detail with reference to FIGS. 33-36.

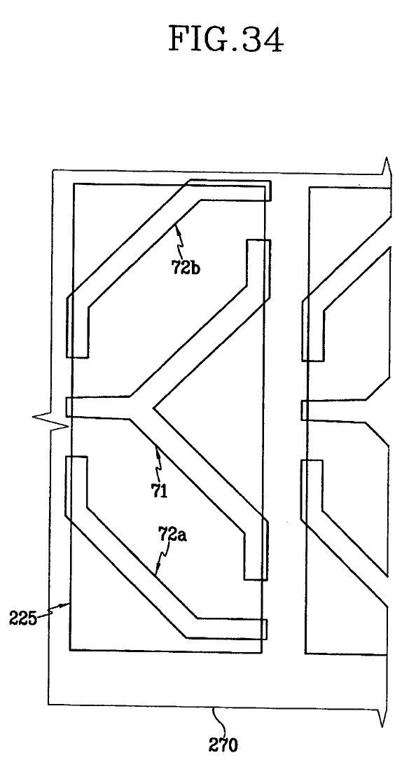

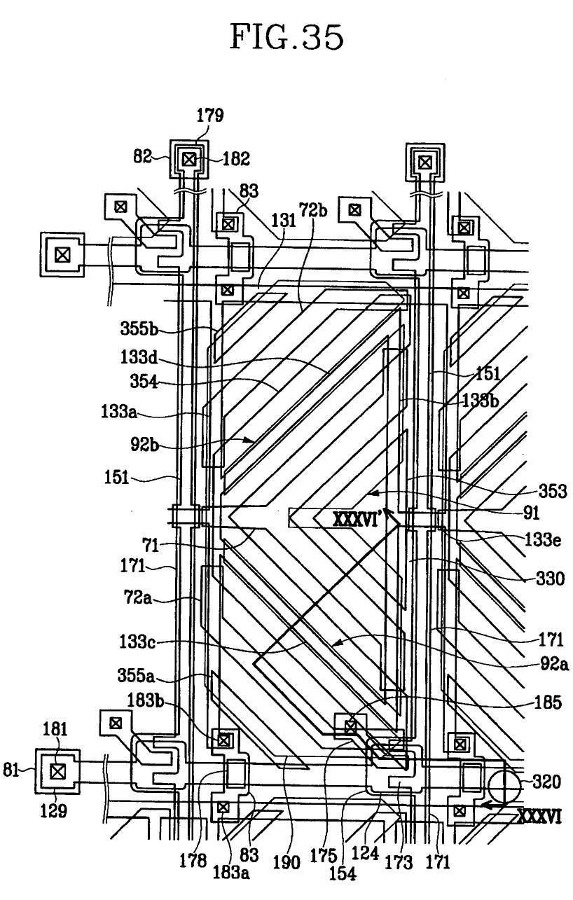

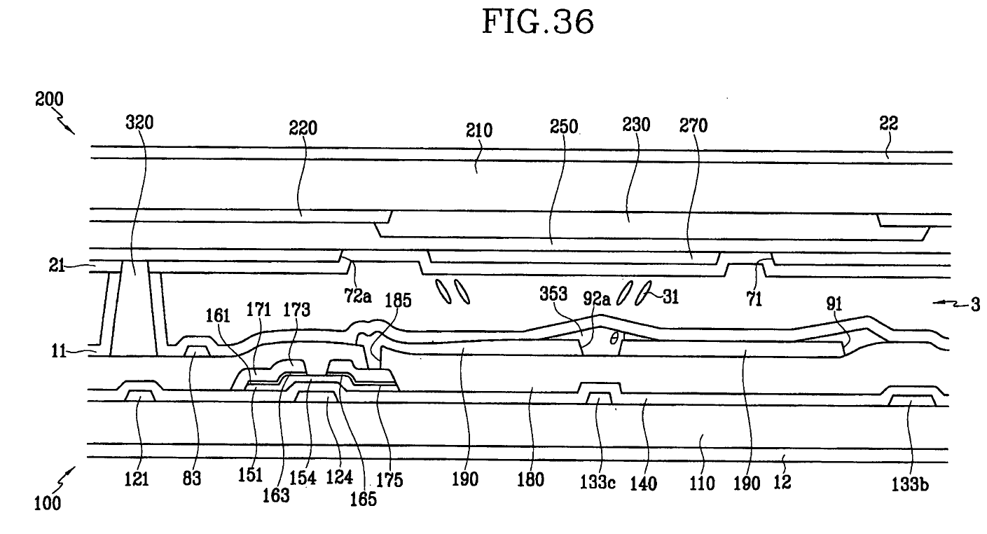

FIG. 33 is a layout view of a TFT array panel for an LCD according to another embodiment of the present invention, FIG. 34 is a layout view of a common electrode panel for an LCD according to another embodiment of the present invention, FIG. 35 is a layout view of an LCD including the TFT array panel shown in FIG. 33 and the common electrode panel shown in FIG. 34, and FIG. 36 is a sectional view of the LCD shown in FIG. 35 taken along line XXXVI-XXXVI′.

Referring to FIGS. 33-36, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 14.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions' 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b and 185 are provided at the passivation layer 180 and the gate insulating layer 140. A plurality of pixel electrodes 190 having a plurality of cutouts 91-92b, a plurality of overpasses 83, and a plurality of contact assistants 81 and 82 are formed on the passivation layer 180. A plurality of slope members 353, 354, 355a and 355b are formed on the pixel electrodes 190, and an alignment layer 11 is formed thereon.

Regarding the common electrode panel 200, a light blocking member 220, a plurality of color filters 230, a common electrode 270 having a plurality of cutouts 71-72b, and an alignment layer 21 are formed on an insulating substrate 210.

In contrast to the LCD shown in FIGS. 1-4, the width of the slope members 353-355b is small and thus the distance between edges of adjacent slope members 353-355b is much smaller than the width of the cutouts 71-72b. The area occupied by the slope members 353-355b is preferably equal to or smaller than about a half of the area of the pixel electrodes 190 and preferably in a range of about 2547.5% of the area of the pixel electrodes 190. The height of the ridge of each of the slope members 353-355b is preferably smaller than about 3 microns, and more preferably in a range of about 0.8-1.2 microns, and the inclination angle of the inclined surfaces relative to the surface of the substrate 110 is preferably in a range of about 1-10 degrees. The dielectric constant of the slope members 353-355b is preferably equal to or less than about 10.

In addition, the semiconductor stripes 151 of the TFT array panel 100 according to this embodiment have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Furthermore, the TFT array panel 100 further includes a plurality of semiconductor islands (not shown) and a plurality of ohmic contact islands (not shown) disposed thereon, which are disposed under the metal pieces 178.

A manufacturing method of the TFT array panel according to an embodiment simultaneously forms the data lines 171, the drain electrodes 175, the metal pieces 178, the semiconductors 151, and the ohmic contacts 161 and 165 using one photolithography process.

A photoresist pattern for the photolithography process has position-dependent thickness, and in particular, it has first and second portions with decreased thickness. The first portions are located on wire areas that will be occupied by the data lines 171, the drain electrodes 175, and the metal pieces 178 and the second portions are located on channel areas of TFTs.

The position-dependent thickness of the photoresist is obtained by several techniques, for example, by providing translucent areas on the exposure mask as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. In detail, once a photoresist pattern made of a reflowable material is formed by using a normal exposure mask only with transparent areas and opaque areas, it is subject to reflow process to flow onto areas without the photoresist, thereby forming thin portions.

As a result, the manufacturing process is simplified by omitting a photolithography step.

Many of the above-described features of the LCD shown in FIGS. 14 are common with the TFT array panel shown in FIGS. 33-36.

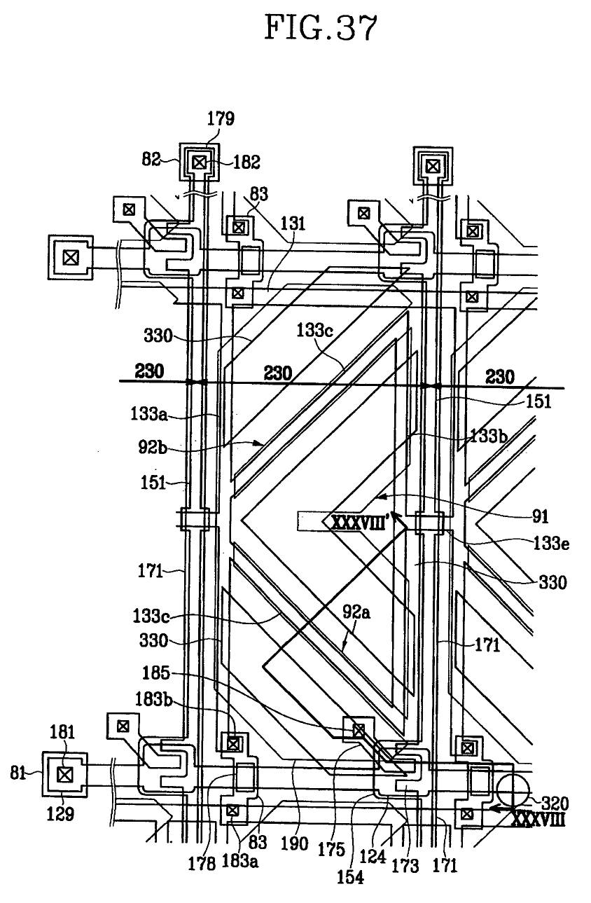

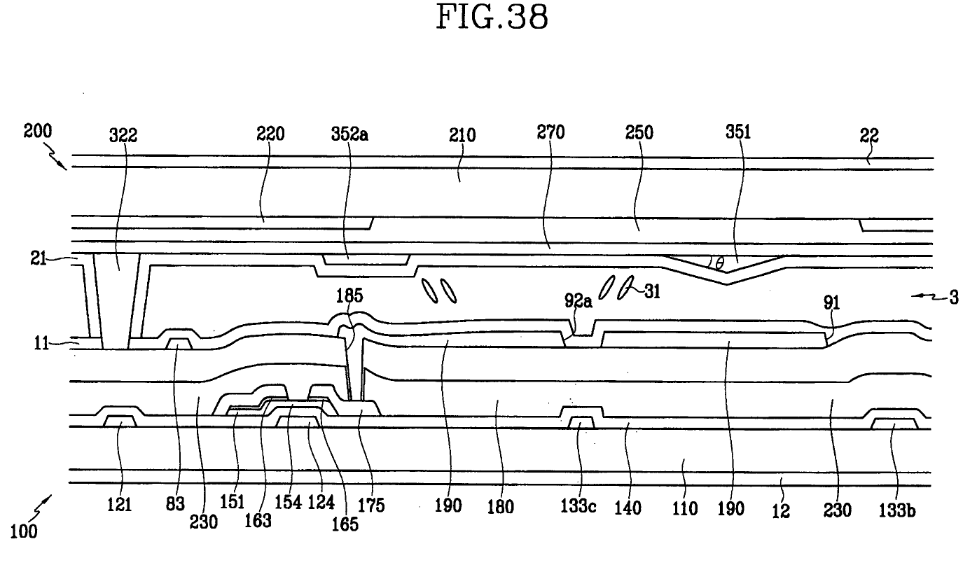

An LCD according to another embodiment of the present invention is described below in detail with reference to FIGS. 37 and 38.

FIG. 37 is a layout view of an LCD according to another embodiment of the present invention, and FIG. 38 is a sectional view of the LCD shown in FIG. 31 taken along line XXXII-XXXII′.

Referring to FIGS. 37 and 38, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are very similar to those shown in FIGS. 29-32.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b and 185 are provided at the passivation layer 180 and the gate insulating layer 140. A plurality of pixel electrodes 190 having a plurality of cutouts 91-92b, a plurality of overpasses 83, and a plurality of contact assistants 81 and 82 are formed on the passivation layer 180, and an alignment layer 11 is coated thereon.

Regarding the common electrode panel 200, a light blocking member 220, a plurality of color filters 230, a common electrode 270, a plurality of slope members 351, 352a and 352b, a plurality of columnar spacers 322, and an alignment layer 21 are formed on an insulating substrate 210.

In contrast to the LCD shown in FIGS. 29-32, the TFT array panel 100 includes a plurality of color filter stripes 230 disposed under the passivation layer 180, while the common electrode panel 200 has no color filter. The color filter stripes 230 extend along a longitudinal direction and edges of adjacent two of the color filter stripes 230 exactly match with each other on the data lines 171, but the color filters 230 may overlap each other to block the light leakage between the pixel electrodes 190, or may be spaced apart from each other. When the color filters 230 overlap each other, a light blocking member 220 disposed on a common electrode panel 200 may be omitted.

Many of the above-described features of the LCD shown in FIGS. 29-32 may be applied to the TFT array panel shown in FIGS. 37 and 38.

The slope members can be applicable to any type of LCDs such as twisted nematic (TN) type LCDs or in-plane switching (IPS) type LCDs.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display panel, comprising:
a substrate having a surface;
a field-generating electrode supported by the substrate;
a slope member supported by the substrate, the slope member including a surface inclined with respect to the surface of the substrate, wherein a lesser included angle between the surface of the substrate and the surface of the slope member defines an inclination angle, and further wherein the inclination angle is less than about 45 degrees.

2. The liquid crystal display panel of claim 1 further comprising a spacer supported by the substrate, wherein the spacer and the slope member are formed from a common layer of material.

3. The liquid crystal display panel of claim 2, further comprising a ground member supported by the substrate, wherein the ground member is formed using the same layer of material used to form the slope member and the spacer.

4. The liquid crystal display panel of claim 3, wherein the ground member is connected to at least one of the slope member and the spacer.

5. The liquid crystal display panel of claim 1, wherein the slope member is comprised of a photosensitive organic material.

6. The liquid crystal display panel of claim 2, wherein the common layer of material is comprised of a photosensitive organic material.

7. The liquid crystal display panel of claim 1, wherein the inclination angle is in a range of about 1-10 degrees.

8. The liquid crystal display panel of claim 1, wherein a surface of the slope member extends from an apex above the surface of the substrate toward the surface of the substrate.

9. The liquid crystal display panel of claim 1, wherein the slope member includes a curvilinear surface.

10. The liquid crystal display panel of claim 1, wherein the slope member includes a ridge and first and second surfaces extending downwardly from the ridge toward the surface of the substrate.

11. The liquid crystal display panel of claim 1, wherein the field generating electrode includes a cutout.

12. The liquid crystal display panel of claim 11, wherein the slope member includes a ridge substantially coinciding with the cutout.

13. The liquid crystal display panel of claim 1, wherein the slope member includes a ridge substantially coinciding with an edge of the field generating electrode.

14. The liquid crystal display panel of claim 1, wherein the slope member is disposed on the field generating electrode.

15. A liquid crystal display comprising:
first and second substrates facing each other in a spaced apart relationship;
first and second field generating electrodes formed on at least one of the first and the second substrates, the first and second electrodes facing each other;
a liquid crystal layer disposed between the first substrate and the second substrates; and
a slope member supported on the first substrate, the slope member including a surface which is inclined with respect to a surface of the first substrate.

16. The liquid crystal display according to claim 15, further comprising a spacer separating the first and second substrates, wherein the spacer and the slope member are formed from a common layer of material.

17. The liquid crystal display of claim 16, further comprising a ground member formed from the common layer of material and extending between the slope member and the spacer.

18. The liquid crystal display of claim 15, wherein a lesser included angle between the inclined surface of the slope member and the surface of the substrate defines an inclination angle, and further wherein the inclination angle is in a range of from about 1-10 degrees.

19. The liquid crystal display of claim 15, wherein a surface of the slope member extends from an apex above the surface of the substrate toward the surface of the substrate.

20. The liquid crystal display of claim 15, further comprising a tilt direction determining member that determines tilt directions of liquid crystal molecules in the liquid crystal layer under an application of an electric field.

21. The liquid crystal display of claim 20, wherein the tilt direction determining member is disposed on the slope member.

22. The liquid crystal display of claim 20, wherein the tilt direction determining member is disposed opposite the slope member.

23. The liquid crystal display of claim 20, wherein the slope member includes a ridge arranged alternate to the tilt direction determining member.

24. The liquid crystal display of claim 20, wherein the slope member includes a ridge arranged alternate to an edge of the first field generating electrode.

25. The liquid crystal display of claim 20, wherein the tilt direction determining member comprises a cutout at the first or the second field generating electrode.

26. The liquid crystal display of claim 20, wherein the tilt direction determining member is disposed on a ridge of the slope member.

27. The liquid crystal display of claim 15, further comprising:
a gate line disposed on the second substrate;
a data line intersecting the gate line; and
a thin film transistor connected to the gate line, the data line, and one of the first and the second field generating electrodes.

28. A method of manufacturing a liquid crystal display panel, comprising:
forming a field generating electrode occupying a first area on a substrate;
depositing an insulating layer; and
patterning the insulating layer to form a plurality of slope members and a plurality of spacers higher than the slope members,
wherein the slope members satisfy at least one of:
(a) each of the slope members includes a surface which is inclined with respect to a surface of the substrate thereby defining an inclination angle, wherein the inclination angle of from about 1-10 degrees;
(b) the slope members occupy a second area larger than half of the first area; and
(c) each of the slope members wherein a lesser included angle between the inclined surface of the slope member and the surface of the substrate defines an inclination angle, and further wherein the inclination angle is in a range of from about 1-10 degrees.

29. The method of claim 28, wherein the patterning of the insulating layer further forms ground portions connected to the slope members and the spacers.

30. The method of claim 28, wherein the insulating layer is comprised of a photosensitive material.

31. A liquid crystal display panel, comprising:
a substrate;
a field-generating electrode formed on the substrate and occupying a first area; and
at least one slope member formed on the field generating electrode and occupying a second area smaller than the first area; and the at least one slope member satisfies at least one of:
(a) the least one slope member has a surface which is inclined with respect to a surface of the substrate thereby defining an inclination angle, wherein the inclination angle smaller than about 45 degrees; and
(b) each of the slope members wherein a surface of the slope member extends from an apex above the surface of the substrate toward the surface of the substrate.

32. The liquid crystal display panel of claim 31, wherein the least one slope member has an inclination angle of from about 1-10 degrees.

33. The liquid crystal display panel of claim 31, wherein the second area is equal to or smaller than about a half of the first area.

34. The liquid crystal display panel of claim 33, wherein the second area is equal to about 25-47.5% of the first area.

35. The liquid crystal display panel of claim 31, wherein the height of the at least one slope member is in a range of about 0.8-1.2 microns.

36. The liquid crystal display panel of claim 31, further comprising a spacer formed of the same layer as the at least one slope member and higher than the slope member.

37. The liquid crystal display panel of claim 31, wherein the field generating electrode has a cutout.

38. The liquid crystal display panel of claim 37, wherein the slope member has a ridge substantially coinciding with the cutout.
